(19) United States
(12) Patent Application Publication
(10) Pub. No.: US 2009/0276297 A1
(43) Pub. Date: Nov. 5, 2009

(54) METHOD AND SYSTEM FOR REVIEWING AND MANAGING EMPLOYEES

(75) Inventors: Stefan Ehrler, Biblis (DE); Kattia Jordan-Philipp, Diehlheim (DE)

Correspondence Address: KENYON & KENYON LLP, 1500 K STREET N.W., WASHINGTON, DC, 20005, US

(73) Assignee: SAP AG, Walldorf (DE)

(21) Appl. No.: 12/167,731

(22) Filed: Jul. 3, 2008

Related U.S. Application Data
(60) Provisional application No. 61/050,622, filed on May 5, 2008.

(51) Int. Cl. G06Q 10/00

(52) U.S. Cl. 705/11

(57) ABSTRACT

A system and method are provided for reviewing employees of a company that includes displaying a grid with potential along one axis and performance along a second axis, and placing each of a select group of employees in one of the boxes defined by the grid. The employees may be moved from one box to another box and the employees may be displayed with an indication of previous box placement. The movements may be tentative then confirmed. The number of employees permitted in a box may be dependent on organizational business needs. A side-by-side comparison of two or more employees may be provided based on organizational needs, e.g. the needs of a position. Rules may be defined for placing employees in boxes based on different evaluation criteria used by different local human resource centers. The preparation and follow-up of employee review meetings may be provided for.

### PRIORITY CLAIM

The present application claims priority to provisional application 61/050,622, filed May 5, 2008.

### FIELD OF THE INVENTION

The present invention relates generally to the area of resource management and, more specifically, to reviewing and managing employees.

### BACKGROUND

Employees are perhaps the most valuable asset of a company. Keeping and attracting employees often requires that the company invest resources to develop the employees. But developing employees is expensive and many companies prefer to focus their development efforts on those employees that are evaluated to have a high potential for their future value to the company. Many companies hold employee review meeting at least once a year to review/evaluate employee potential. Many companies will set organizational goals which may drive some of the employee review/evaluation process. For example, a company may determine that a fixed number of employees are going to be in line to succeed an important position of the company, or the company may determine that a fixed number of employees will receive the opportunity for special training. These organization goals may determine how many employees may be assessed to have a high potential for the company. The employees that are deemed to have an above average value to the company may be called talents.

Many companies will evaluate the talents into a fixed number of categories for potential. So, for example, the employee may have a performance evaluation rating, and a potential rating, which may simply be low, medium, or high. The performance rating may have been from the employee's manager or a human resource (HR) business partner, and reflect the manager's and/or HR business partner's assessment of the actual past performance of the employee. The potential for the employee, may be evaluated by a different group of managers and/or HR business partners, and reflect the potential the company has evaluated the employee to have.

There may be a group of managers and/or HR business partners of the company that evaluate the employees in a review meeting. Often in the review meeting, employees who are nominated to become talents by their managers and/or human resource personnel are considered for whether or not they should become talents by a larger group of managers and/or HR business partners. Other topics of the employee review meetings may include a discussion of the development of the talents selected at the past talent review meeting, a discussion of the nominated talents for the current talent review meeting, a discussion of potential successors for selected key positions, a discussion of the selection of talents for key positions, and discussions of positions with a strategic importance (critical roles/role clusters.) Critical roles/role clusters are groupings of jobs or positions with a strategic relevance (e.g. management, revenue, rare skills) that require a pipeline of talents (successor bench) in place in case a vacancy occurs. Other topics covered in the review meeting may include calibration of talents selected in previous years. Calibration means that the employees that have already been selected as talents are evaluated for whether they should be moved to another category of potential.

For large companies there may be local and global meetings. Often several meetings are held and the results are cascaded up for final decisions at higher management levels. The employee review meeting may have multiple groups of nominated talent and/or talent to consider.

The amount of information that can be relevant to performing employee reviews/evaluations is enormous and the cost of making less than optimum decisions may mean not selecting the best employees for positions and future development. Further, many methods for performing employee reviews are time consuming and prone to error because potentially relevant information is not readily available to the reviewer or the information is not presented to the reviewer with the proper context.

Accordingly, there is a need in the art for improved systems and methods for reviewing and managing employees.

### BRIEF DESCRIPTION OF THE DRAWINGS

FIG. 1 illustrates a portfolio grid which is part of an integrated system for talent management.

FIG. 2 illustrates one mode of display for comparing the talents in a portfolio grid.

FIG. 3 illustrates one mode of display for comparing talents as a list with various attributes of the talents in columns.

FIG. 4 illustrates one mode of the display for comparing talents in a baseball card like mode.

FIG. 5 illustrates one mode of the display for comparing talents in a baseball card like mode.

FIG. 6 illustrates one mode of display for comparing talents in a portfolio grid.

FIG. 7 illustrates a talent being moved from box of the grid to another box of the grid.

FIG. 8 illustrates two talents and being compared head-to-head with many details.

FIG. 9 illustrates that additional talent groups can be displayed on the grid

FIG. 10 illustrates that different agenda items can be set up before the talent review meeting and then selected during the talent review meeting.

FIGS. 11, 12, and 13 illustrate the details that may be included in a personnel file for an employee or talent.

FIG. 14 illustrates an interface for managing talent review meetings.

FIG. 15 illustrates an embodiment of a portfolio grid which is part of an integrated system for talent management.

FIG. 16 illustrates an embodiment of a portfolio grid which is part of an integrated system for talent management.

FIG. 17 illustrates an embodiment of a portfolio grid which is part of an integrated system for talent management.

FIG. 18 illustrates an embodiment of a list view which is part of an integrated system for talent management.

FIG. 19 illustrates an interface for managing talent.

FIG. 20 illustrates an interface for planning a talent review meeting, which may have been reached after selecting “Create” from FIG. 19.

FIG. 21 illustrates an interface for planning review meetings.

FIG. 22 illustrates an interface for planning as FIG. 21 except that a button has been selected to display the participants in an organizational hierarchy rather than a list.

FIG. 23 illustrates an interface for notifying the participants of the talent review meeting of the meeting time and place.

FIGS. 24-33 illustrate the preparation of a talent review meeting.

FIGS. 34-38 illustrate the assessment of talent.

FIGS. 39-45 illustrate the self assessment of a employee.

FIG. 46 illustrates an embodiment of a method for reviewing and managing employees.

FIG. 47 illustrates an embodiment for a system for reviewing and managing employees.

### DETAILED DESCRIPTION

The present invention provides for reviewing and managing employees of a company that includes displaying a grid with potential along one axis and performance along a second axis, and placing each of a select group of employees in one of the boxes defined by the grid. The present invention may indicate previous box placement of the employees. The present invention may provide for responding to a selection of two employees and displaying a side-by-side comparison of the two employees for evaluating the two employees. The present invention may provide for displaying a side-by-side comparison of the two employees based on a position in the company the two employees are being considered for. The present invention may provide for defining a set of rules for placing the selected group of employees in boxes, and retrieving evaluations of the selected group of employees from at least two local human resources centers that use different performance values for evaluating the selected group of employees, and placing each of the selected group of employee in one of the boxes using the rules. In an embodiment, the present invention may provide for displaying boxes with an indication of the number of employees that can be placed in the box. In an embodiment, the present invention may provide for responding to a selection of an employee and a drag-and-drop operation by moving the employee from the current box to a new box and providing an indication of which box the employee was moved form. In an embodiment, the present invention may provide for responding to a selection of making an employee movement confirmed and displaying with the employee an indication that the move is confirmed. In an embodiment, the present invention may provide for setting the number of employees that can be confirmed members of a box being dependent on a set of business organization goals and/or rules. In an embodiment, the present invention may provide for an employee being assigned a particular organizational role based on the box the employee has been placed in. The organizational role may define the employee evaluation criteria and the employee's duties. In an embodiment, the present invention may provide for the preparation of talent review meetings, which may include selecting talents/employees for review, creating agendas, selecting succession plans that need to be filled, selecting talent development, selecting organization needs, and selecting positions that need to be filled. In an embodiment, the present invention may provide for follow-up actions after a talent review meeting which may include minutes, talent development follow-up's, and succession follow-up's.

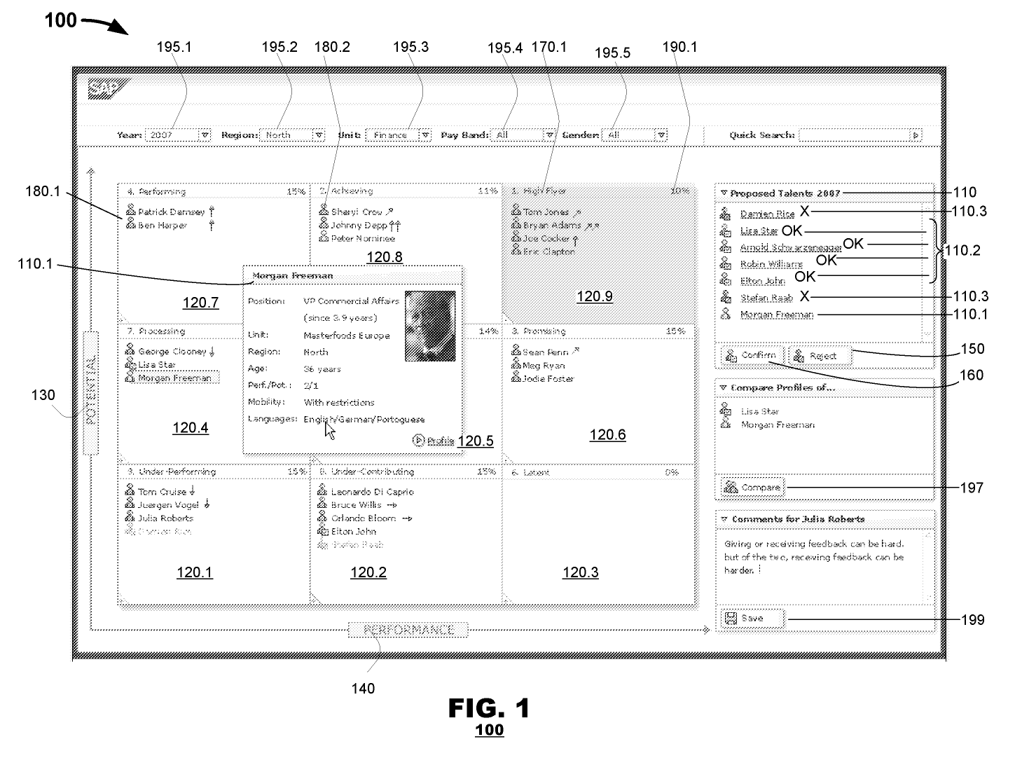

FIG. 1 illustrates an example portfolio grid 100 which is part of an integrated system for talent management. The portfolio grid 100 aids managers during a talent review meeting in making decisions on a group of proposed talents 110 and making decisions on the existing talent 180. In an embodiment, the managers evaluate whether or not to “Confirm” 160 or “Reject” 150 the proposed talents 110, and assign the confirmed proposed talent 110 to one of the categories of the potential axis 130. The managers may evaluate the existing talent 180 to determine whether or not to keep the existing talent 180 (180.1 and 180.2 with the other existing talent not labeled on the portfolio grid 100) in their potential category 130 or to lower or raise their potential category 130. In an embodiment, the portfolio grid 100 may be displayed in a room with multiple managers evaluating the employees. The term manager may be used to include HR business partners as well as other personnel of the company.

The portfolio grid 100 provides an example of a matrix view with the number of boxes 120.1-120.9 depending on the number of categories the company has defined for the potential axis 130 and the performance axis 140. As illustrated there are nine (9) boxes defined by the two axes. As illustrated, the categories for the potential axis 130 are “Low”, “Medium”, and “High.” As illustrated, the categories for the performance axis 140 are “Low”, “Medium”, and “High.” Each box may have a label, e.g. the box for performance axis 140 “High” and potential axis “High” is labeled “1 High Flyers” 170.1. Each proposed talent 110 may be placed in one of the boxes 120 based on the performance assessment (evaluation) the proposed talent 110 has already received from their manager and based on a proposed assessment (evaluation) of their potential. The managers may change the performance assessment or the managers may make decisions on the potential assessment. Performance combination rules (not illustrated) for combining local HR evaluation of employees may be used to place the talents 110 in a performance category. The Performance Combination Rules may be needed because the company may have different performance criteria for different local HR departments, e.g. one HR department may rank employees on a scale of 1-10 and another one may rank employees on a scale from 1-15.

As illustrated four (4) proposed talents 110.2 have been “Confirmed” 160, two (2) 110.3 have been rejected “150”, and one (1) Morgan Freeman 110.1 is still under consideration. The current talents 180 may be moved from one box 120 to another box 120 by, for example, a drag and drop operation. Moving existing talents 180 to new boxes 120 may be called calibration. Arrows may be used to indicate the movement of the current talent 180 from the previous location in the last talent review process. E.g., Sheryl Crow 180.1 has been moved from box 120.4, medium potential and low performance, to box 120.8, high potential and medium performance.

The number of total talents that can be placed in each box 120 and the benefits/responsibilities associated with each may be dependent on organizational business needs. For example, as illustrated only 10% 190.1 of the proposed talent 110 and existing talent 180 may be placed in the “High Flyer” box 120.9. The box may indicate that there are too many talents in the box for the organization business goals by, for example, becoming shaded if there are too many proposed talents 110 and existing talents 180 placed in the box 120.

In addition to moving existing talents 180 and proposed talents 110 (or confirming 150 or rejecting 160 proposed talents), the review meeting may also include succession planning, decisions for filling open positions, and reviews of development actions for existing talents 180.

The existing talents 180 and the proposed talents 110 may be one of many groups of talent within the company. Different groups of talent may be selected for review, or for inclusion with the current talent group for review by, for example, using the controls 195. Existing talents 180 and proposed talents 110 may be part of more than one talent group.

In an embodiment, proposed talent 110 and/or existing talent 180 may be compared with one another by selecting two talents 110, 180, and then pressing the compare button 197. The comparison may be context sensitive to the business organization needs or to a proposed position that the talents are being compared for.

In an embodiment, the entire session of the talent review may be made tentative and unconfirmed until the entire talent review is confirmed. The axes 130, 140 may be switched by user choice. In an embodiment, the axes 130, 140 may be switched during a system configuration. The axes 130, 140 may have more or less than three (3) categories. In an embodiment, there may be additional axes 130, 140 relating to either the talents 110, 180, or the business organizational needs. For example, an additional axis illustrating the experience of the talents to form a three dimensional grid may be displayed.

In an embodiment, the portfolio grid 100 may be displayed on multiple computers with multiple participants collaborating at a distance. In an embodiment, the portfolio grid 100 may be configured so that groups or individuals can make independent assessments and then combine their independent assessments in a sequential or parallel fashion.

The execution of a talent review meeting may involve calibration via interactive portfolio grid, succession planning, talent presentation (talent profile), and decisions for top talent and high potential talents.

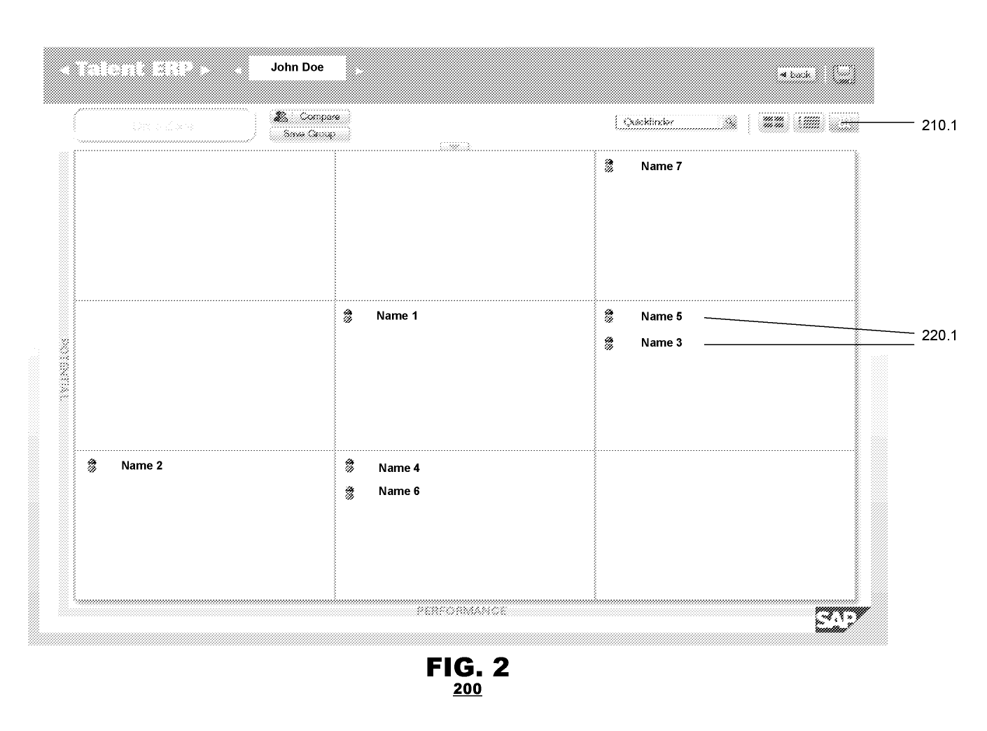

FIG. 2 illustrates an example of one mode of display for comparing the talents 220 in a portfolio grid 200. The button 210 may select the portfolio grid 200.

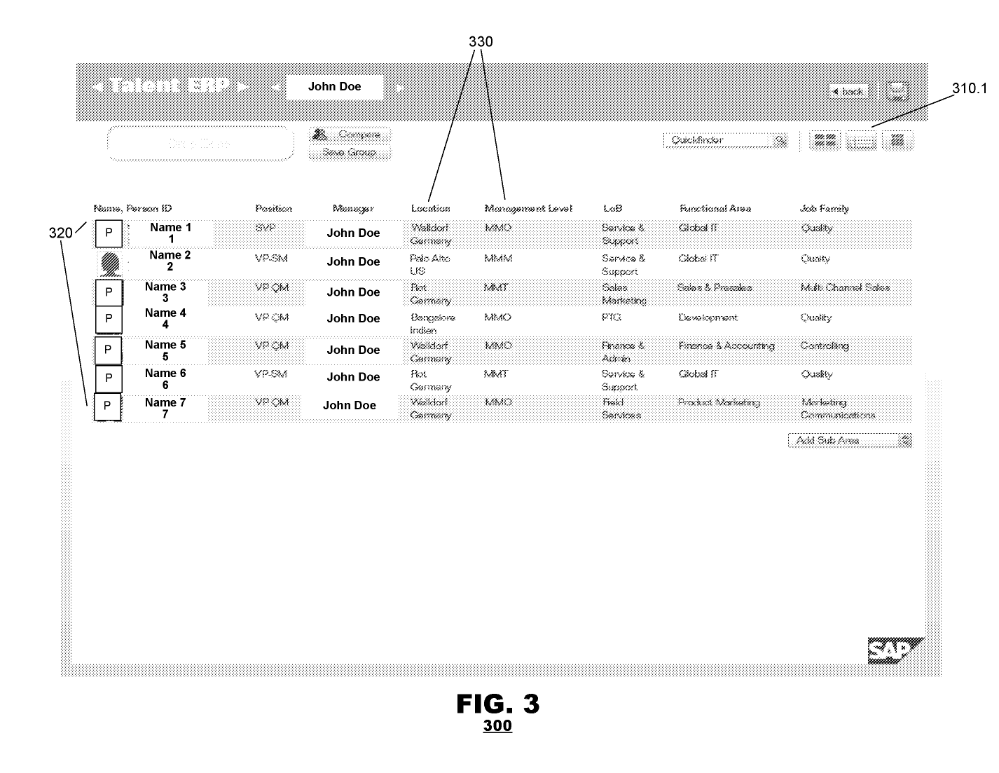

FIG. 3 illustrates an example of one mode of display for comparing talents 320 as a list with various attributes of the talents 320 in columns 330.

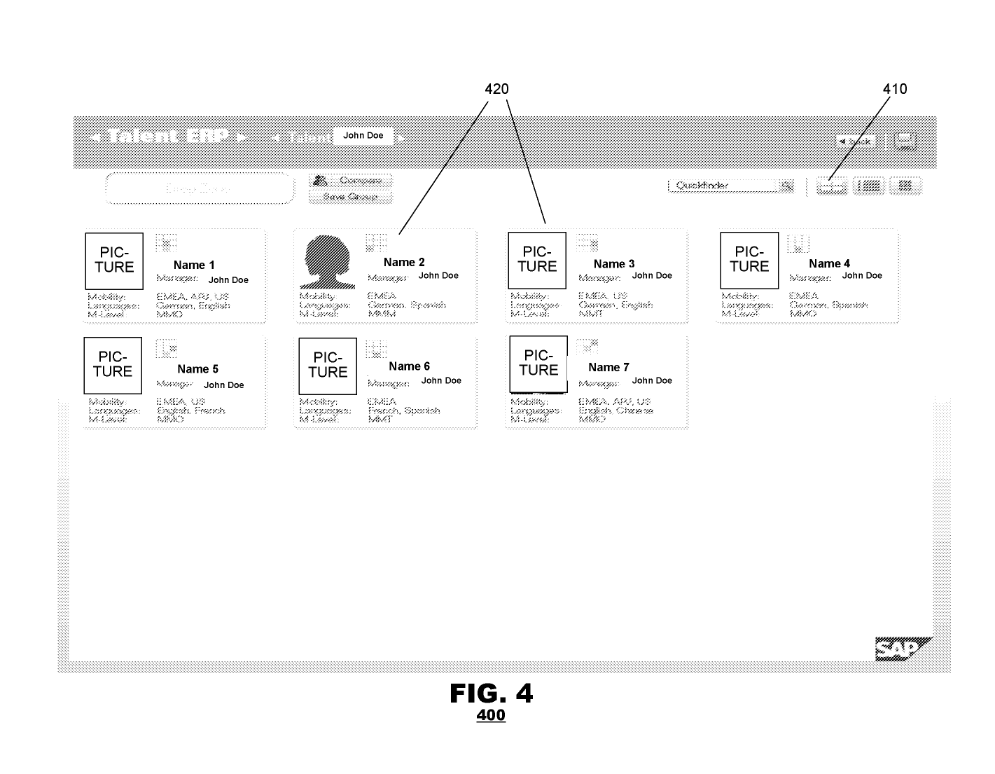

FIG. 4 illustrates an example of one mode of the display for comparing talents 420 in a baseball card like mode. The button 410 may select this mode.

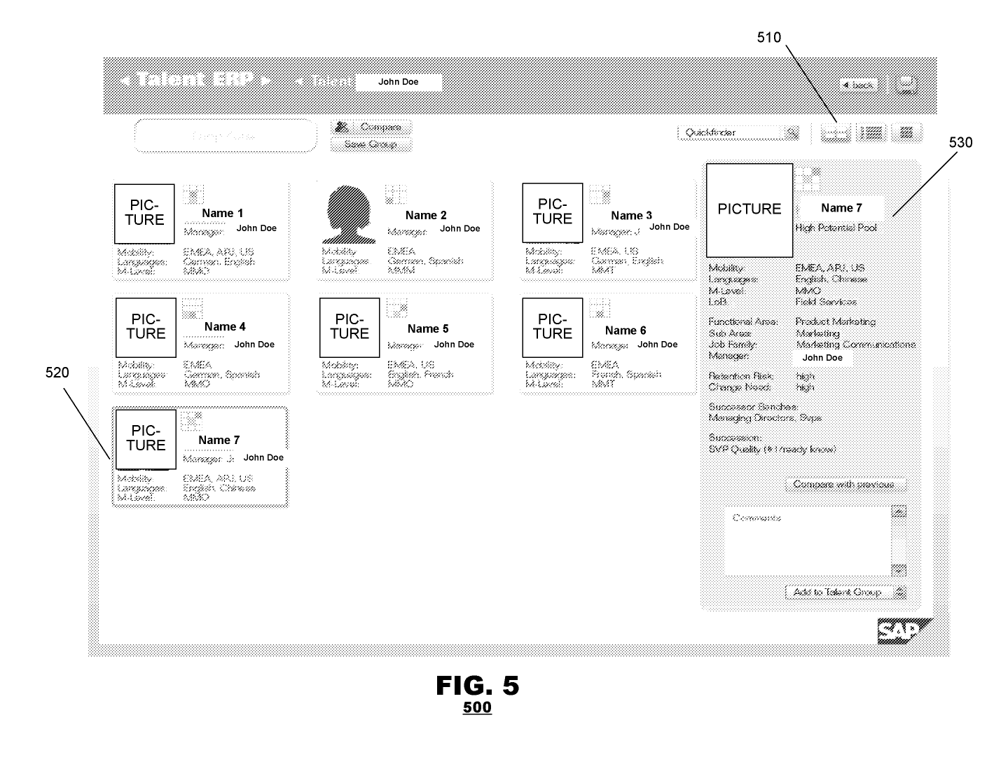

FIG. 5 illustrates an example of one mode of the display for comparing talents 520 in a baseball card like mode. The button 510 may select this mode. Details for a talent 520 may be displayed 530 by selecting the talent 520.

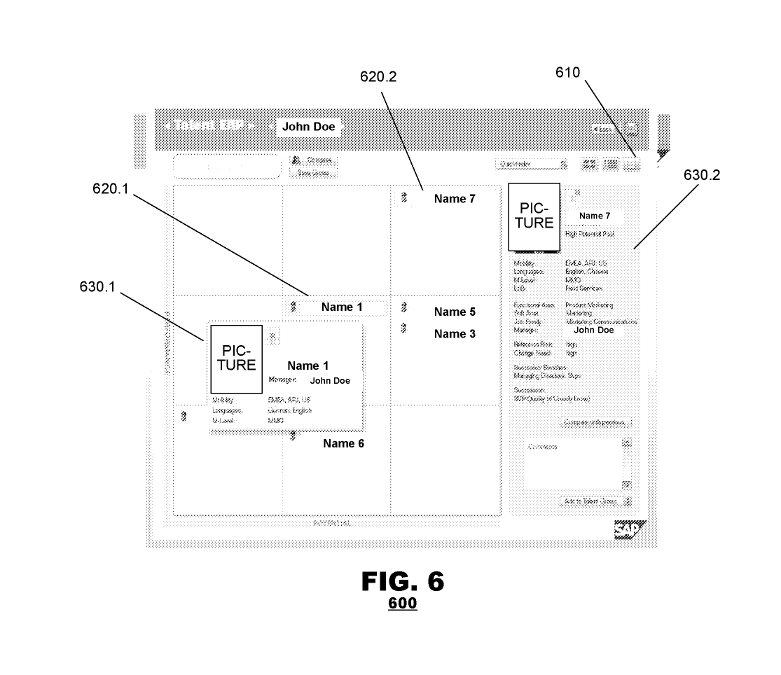

FIG. 6 illustrates an example of one mode of display for comparing talents 620 in a portfolio grid 600. The button 610 may select the portfolio grid 600. As illustrated, two talents 620.1 and 620.2 are selected for comparison with one another. The two talents 620.1 and 620.2 show greater detail 630.1 and 630.2.

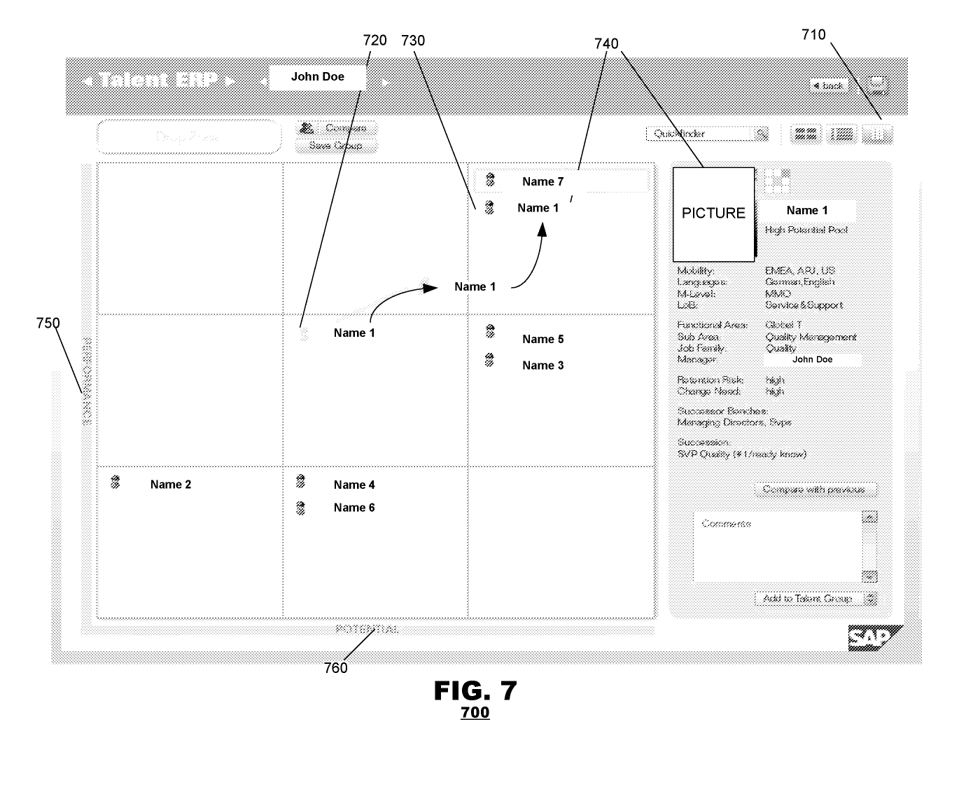

FIG. 7 illustrates an example of a talent being moved from box 720 of the grid 700 to another box 730 of the grid 730. In this case, both the performance 750 and potential 760 were increased for the talent 740. The movement to a new box 730 may be temporary and may need to be confirmed. The confirmation may need to be performed by different managers and the managers that may confirm a movement or selection may be based on the business organization needs. The movement from one box 720 to another box 730 may be animated. Details about the talent 740 may be displayed while and after the talent has been moved to a new box 730.

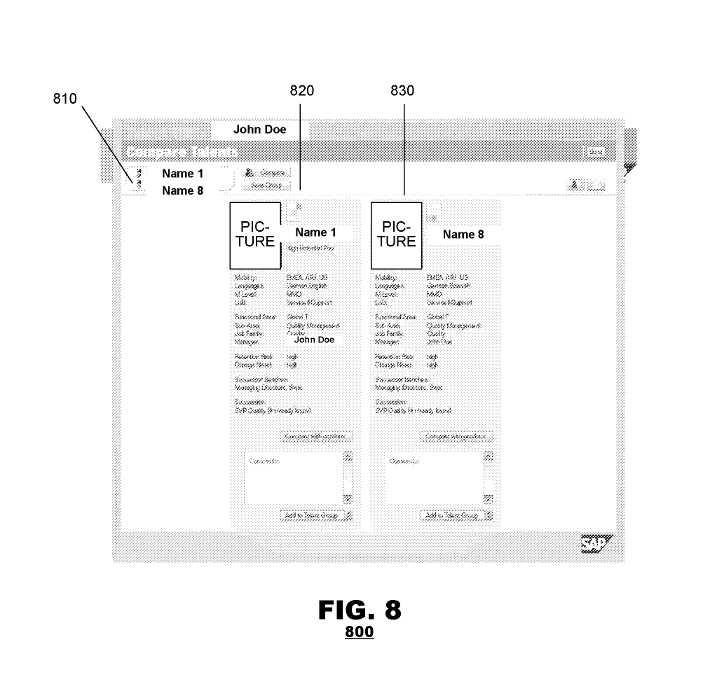

FIG. 8 illustrates an example of two talents 820 and 830 being compared head-to-head with many details. As illustrated, the two talents 820 and 830 were selected at 810. The details displayed may be dependent on business organization needs related to the talent group or the needs for a line of succession or a position.

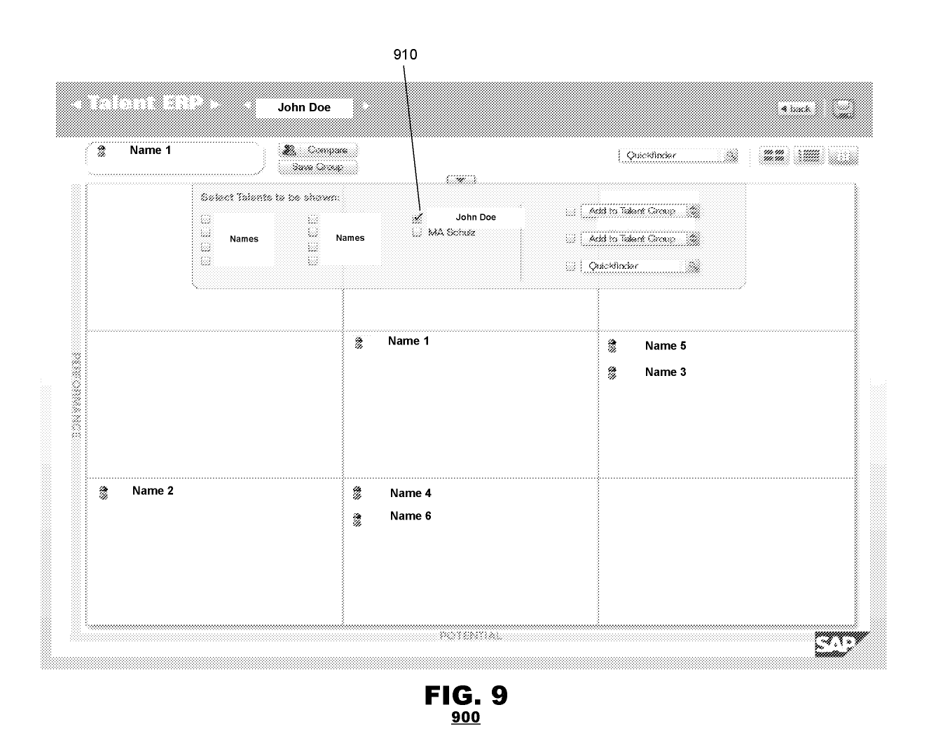

FIG. 9 illustrates an example of how additional talent groups can be displayed on the grid 900. Here the proposed talents for manager Muller are to be displayed on the grid 900 with the existing talent group.

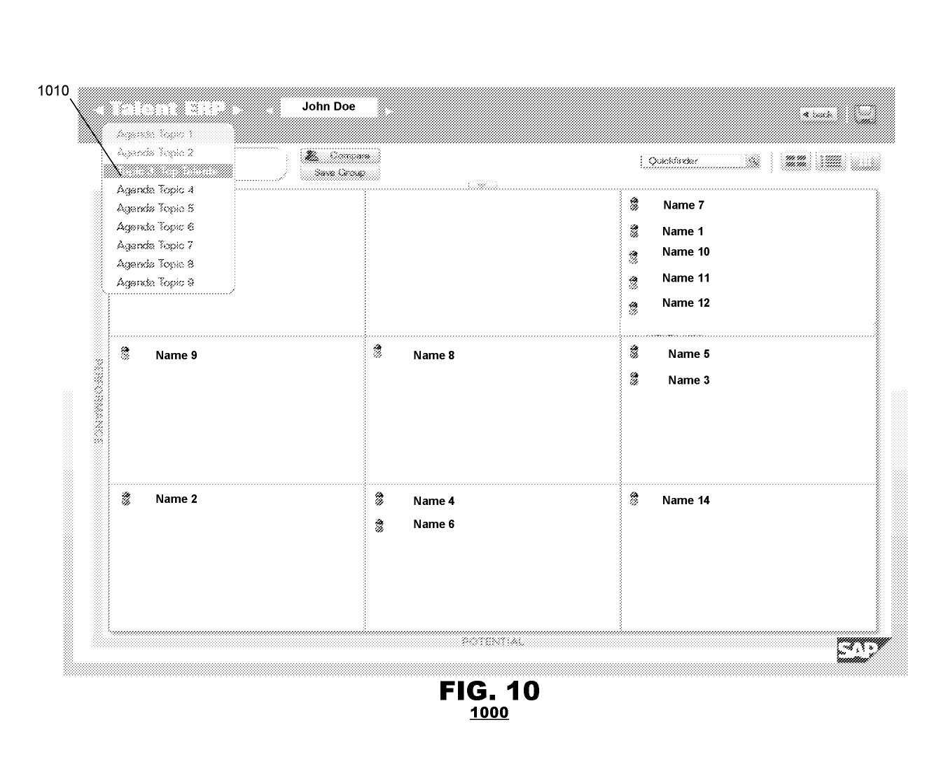

FIG. 10 illustrates an example of how different agenda items 1010 can be set up before the talent review meeting and then selected during the talent review meeting. The agenda items may be associated with groups of talents to review.

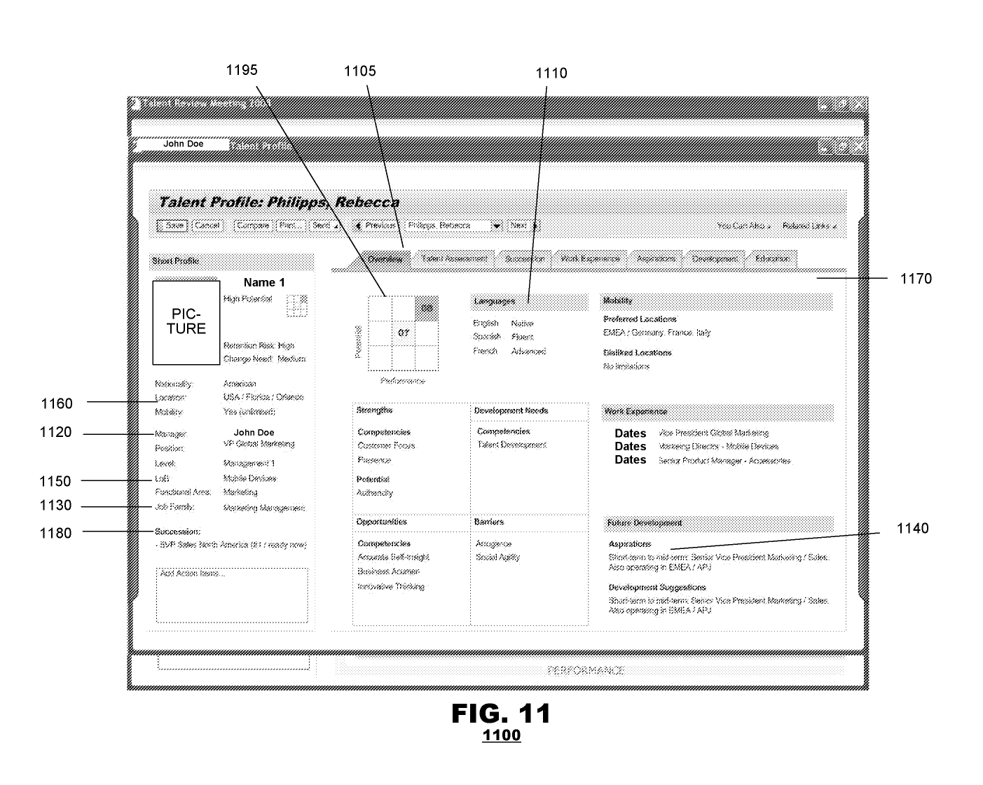

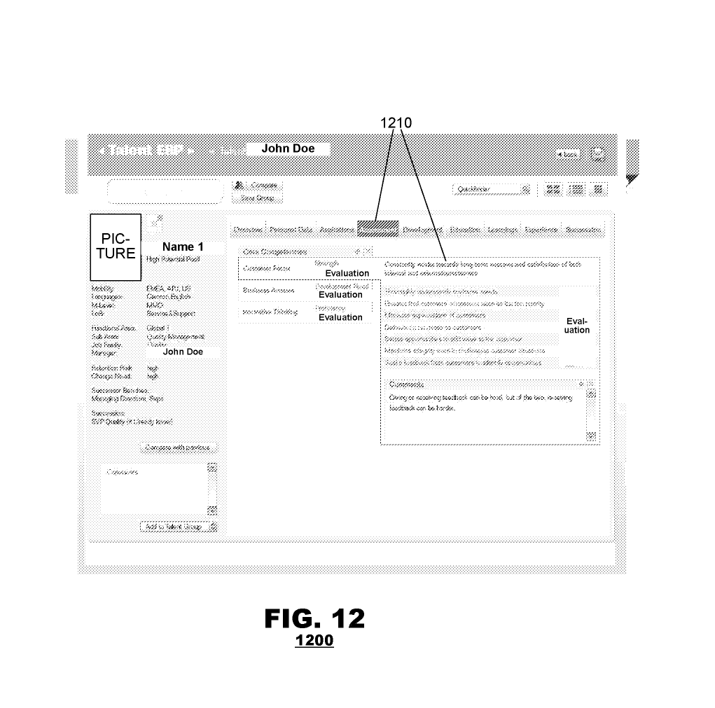

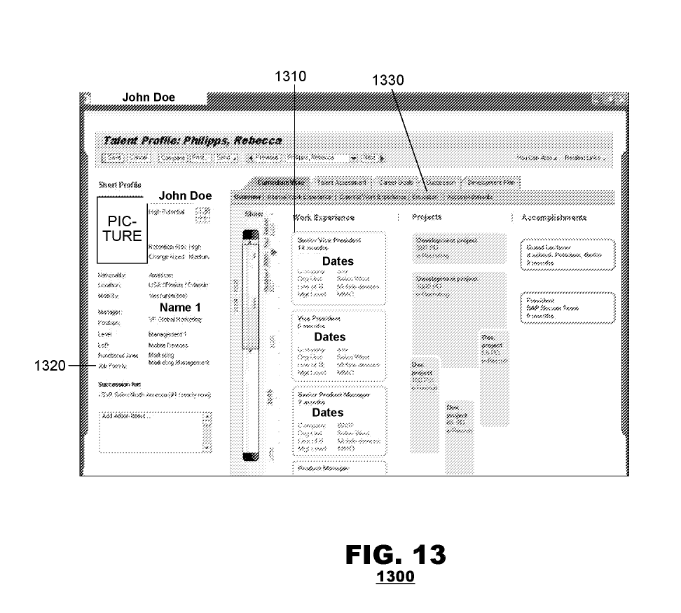

FIGS. 11, 12, and 13 illustrate examples of the details that may be included in a personnel file for an employee or talent. The information may be organized into categories with a menu bar 1105 for selecting a category. As illustrated, “Overview” is selected in FIG. 11. The information may include languages 1110, functional area 1120, job family 1130, aspirations 1140, line of business (LoB) 1150, management level 1160, mobility 1170, succession (proposals or confirmed) 1180, succession benches (proposed or confirmed), job grading (with historical information of previous and current grid placement) 1195, talent assessment 1210, key positions 1310, job and position profile (fact sheet) 1320, and education 1330.

The information included in a personnel file may include company and external information relating to the employee's career, education, and preferences. The information may include data entered by managers and HR business partners, and by the employee/talent, as well as succession proposals, and development items.

Individual development plans may also be assessed during a talent review meeting. Individual development plans may include: career aspirations and desired or selected career path, e.g. management, project, or expert; preferences and aspirations of the talent to aid in identifying development objectives for the talent; agreements between the talent & manager on measures to take and steps to take for the development action; definitions of different types of development actions; the owner of the development action; a due date for the development action; notes on the action type for the development action; a text description of the development action; and, an assignment of a training measure.

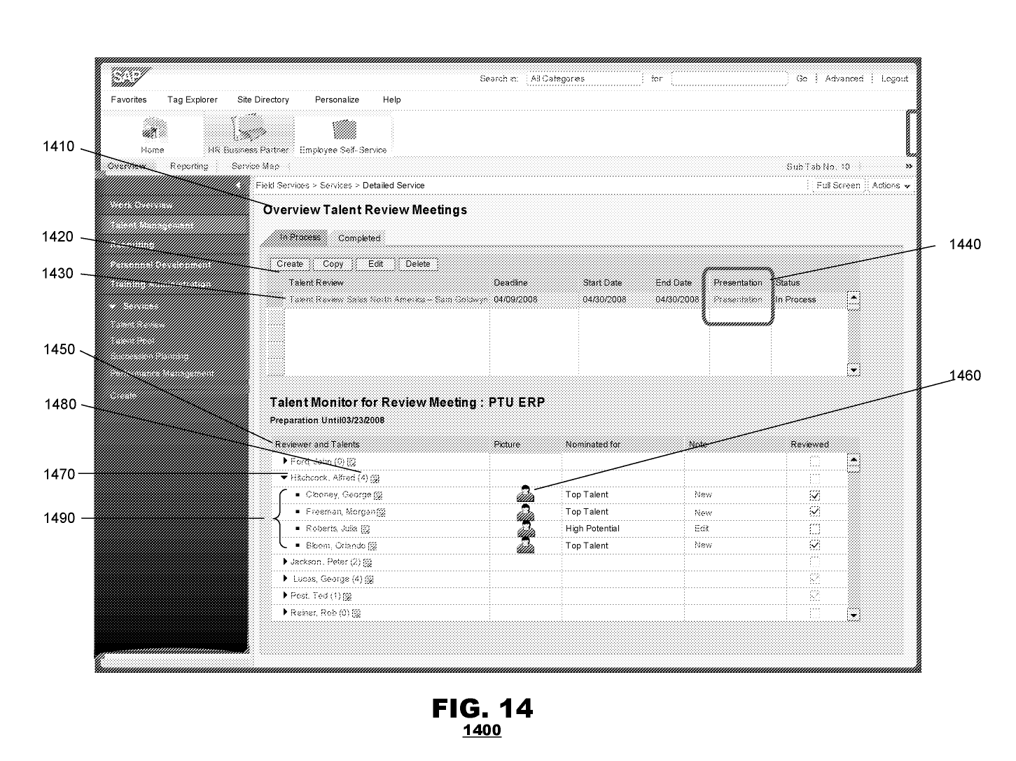

FIG. 14 illustrates an example of an interface for managing talent review meetings. An overview of the talent review meetings is presented 1410. A list of talent review meetings is provided 1420. As illustrated a talent review meeting is selected 1430. The talents for the selected talent review meeting 1430 are listed 1450. The display of a talent may include a picture of the talent 1460. The display of the talents may be organized by managers 1470 with the number 1480 of employees the manager 1470 has that are to be reviewed at the selected talent review meeting 1430.

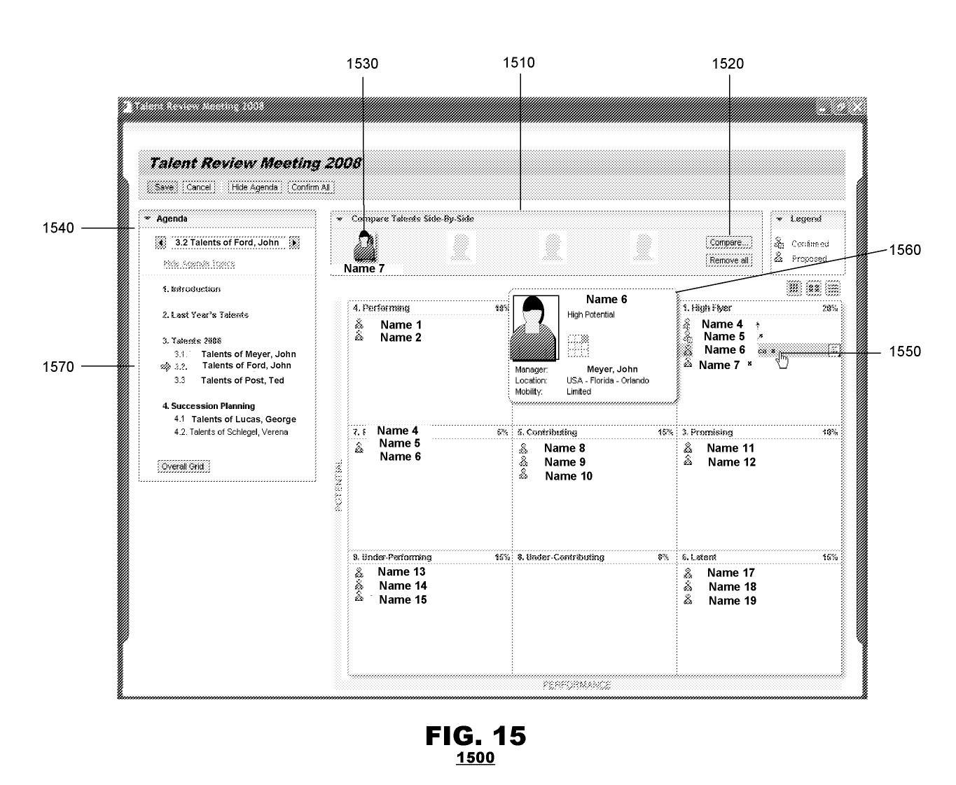

FIG. 15 illustrates an example of an embodiment of a portfolio grid 1500 which is part of an integrated system for talent management. The portfolio grid 1500 may provide a box labeled “Compare Talents Side-by-Side” 1510 where talents can be moved into the box, e.g. dragged and dropped. The button compare 1520 may then be selected to compare the talents in the “Compare Talents Side-by-Side” box 1510. As illustrated one proposed talent, “Name 7”, is in the “Compare Talents Side-by-Side” box 1510. And, as illustrated one talent “Name 6” 1550 has been selected for additional details 1560. The portfolio grid 1500 also provides for displaying the agenda 1540 for the talent review meeting. The agenda 1540 may provide for selecting a talent category as illustrated “Talents of Ford, John” 1570. The “Talents of Ford, John” 1570 would then be displayed on the portfolio grid 1500.

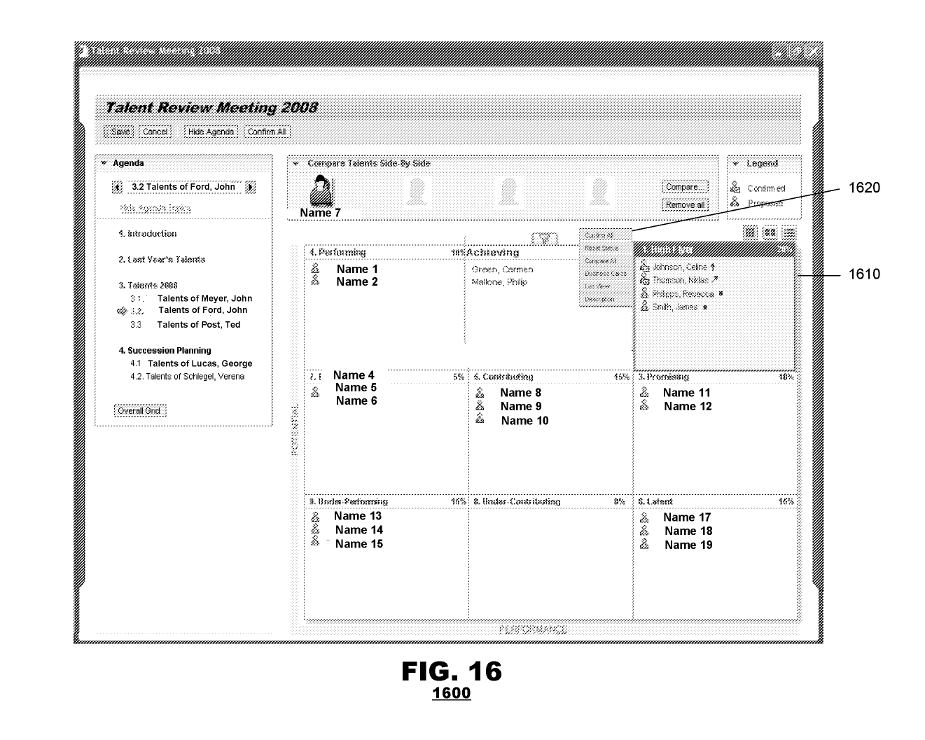

FIG. 16 illustrates an embodiment of a portfolio grid 1600 which is part of an integrated system for talent management. A box 1610 of the portfolio grid 1600 may be selected and options 1610 that apply to the talents in the box 1610 displayed. One of the options 1610 may then be selected to apply to the talents in the box 1610.

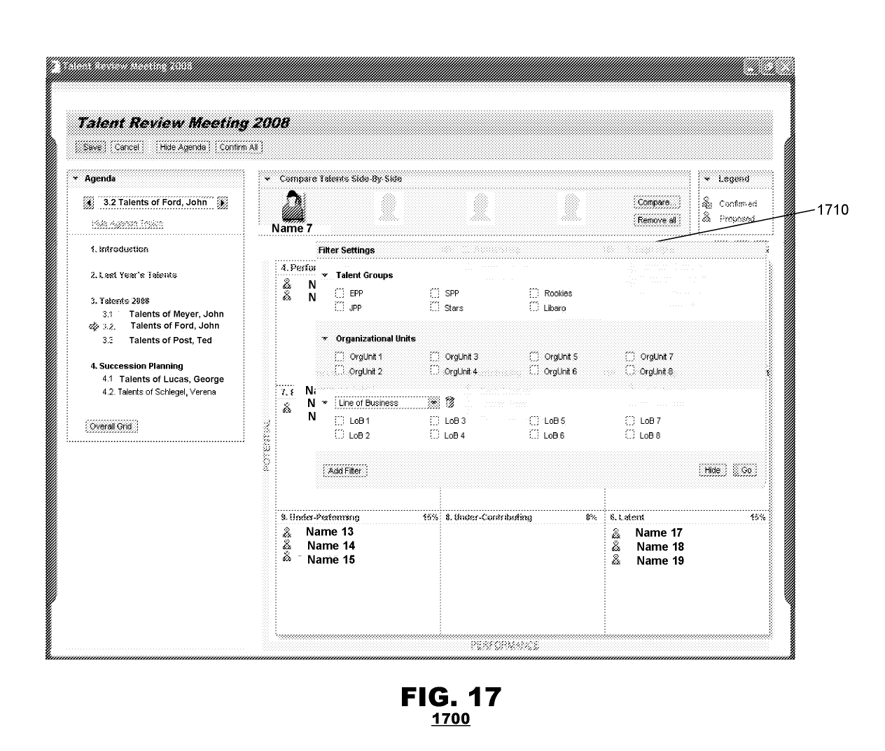

FIG. 17 illustrates an embodiment of a portfolio grid 1700 which is part of an integrated system for talent management. Filter settings 1710 may be displayed for selecting which talents to display on the portfolio grid 1700.

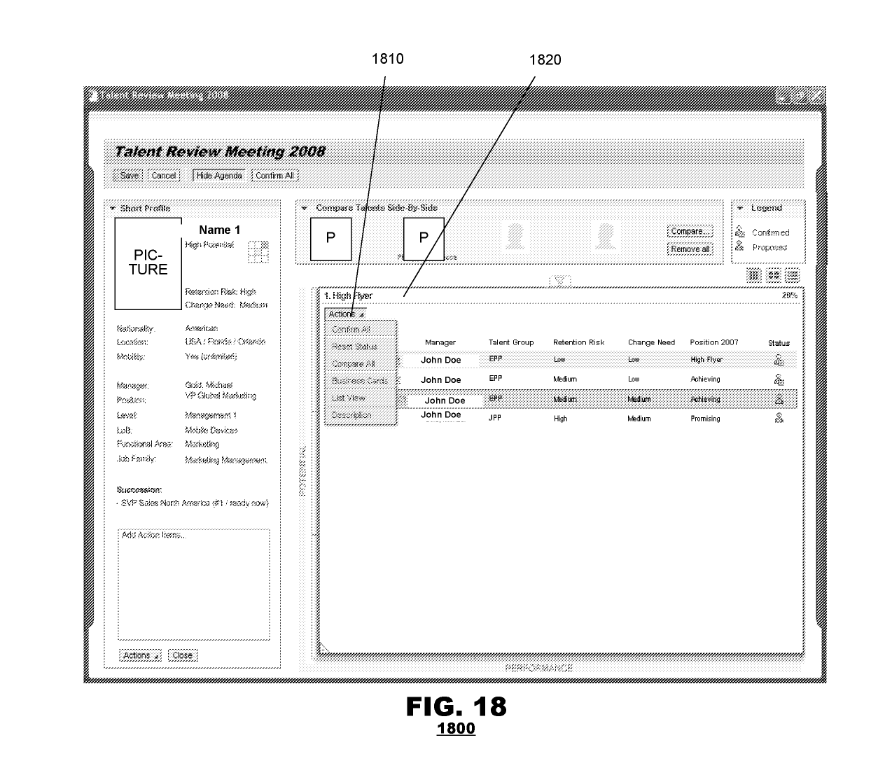

FIG. 18 illustrates an embodiment of a list view 1800 which is part of an integrated system for talent management. Illustrated is one box “High Flyer” 1820 of the portfolio grid 1800 in a list format. A menu 1810 may be displayed for taking action on the entire box 1820 or a menu may be displayed for taking action on individual talents being displayed.

Planning/preparation for talent review meeting may include: invitations, agenda and participants, nominations of talents and proposals for positions and development actions and successions, and handouts for the participants.

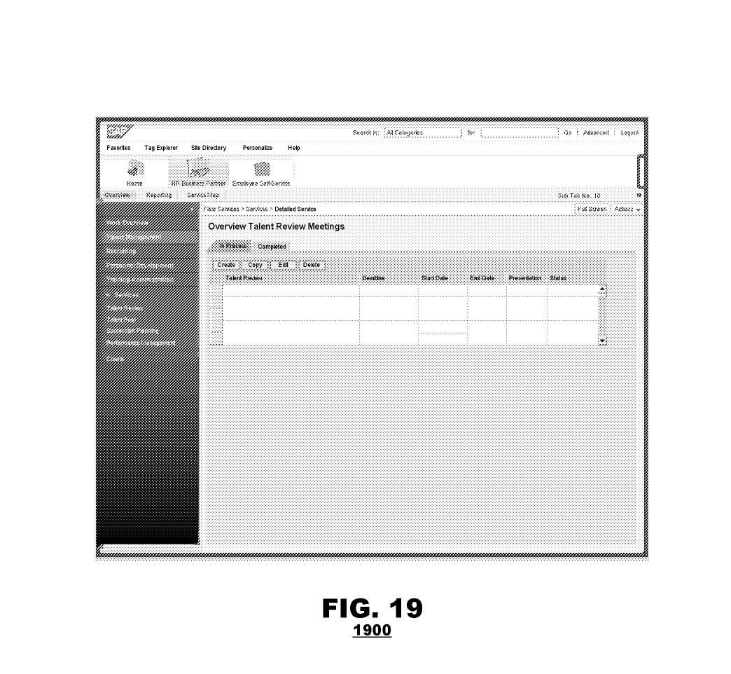

FIG. 19 illustrates an example of an interface for managing talent 1900. As illustrated “HR Business Partner” is selected and “Talent Management” is selected. The “In Process” tab is selected. As illustrated there are currently no talent review meeting. In an embodiment, a talent review meeting may be created, copied, edited, or deleted.

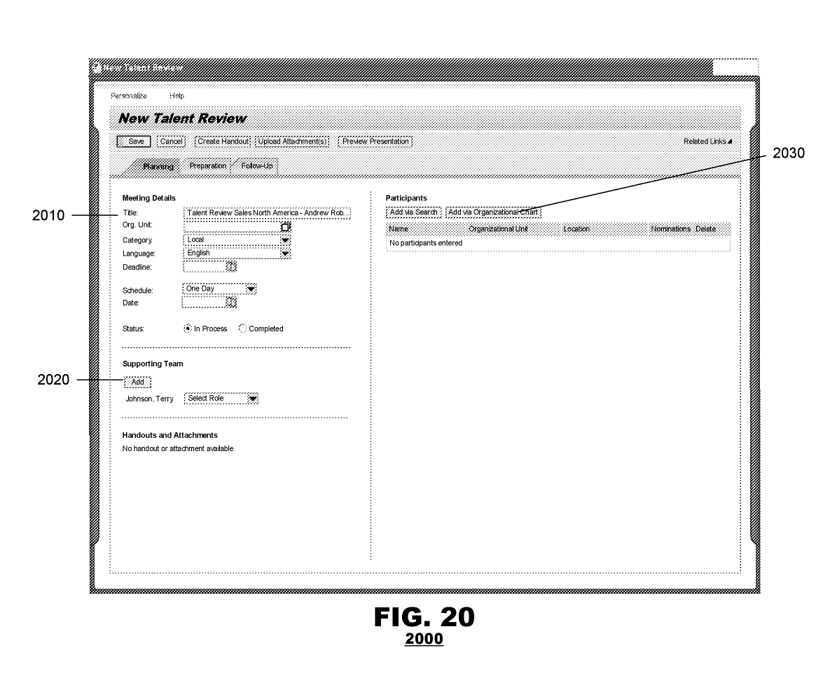

FIG. 20 illustrates an example of an interface for planning a talent review meeting, which may have been reached after selecting “Create” from FIG. 19. Meeting details 2010, support staff 2020, and participants and reviewer 2030 can be set.

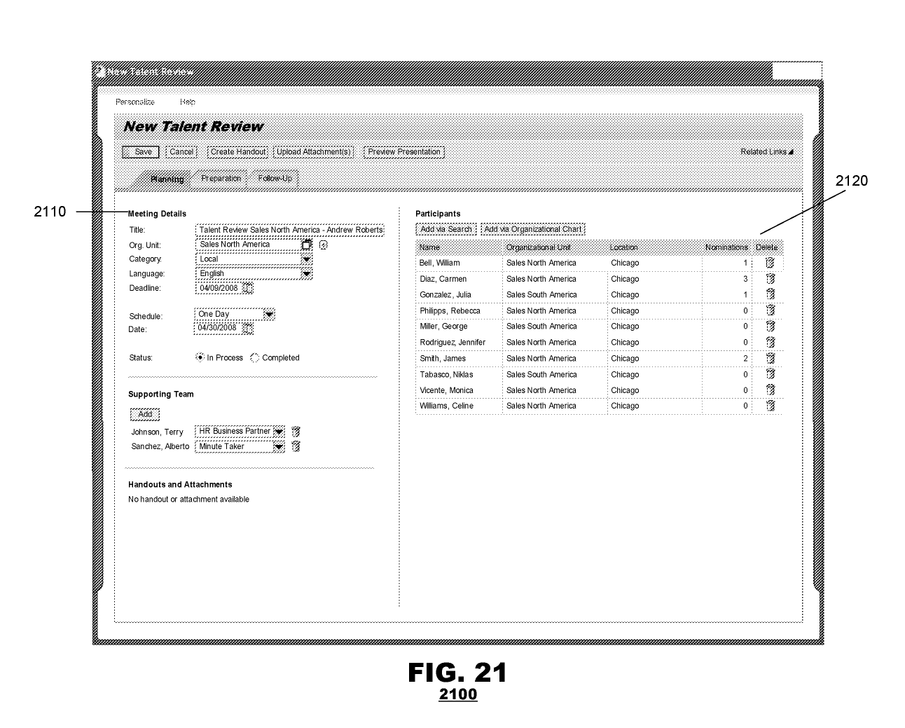

FIG. 21 illustrates an example of an interface for planning review meetings 2100. The organizational unit has been selected 2110, which in this case determined the participants 2120 for the talent review meeting.

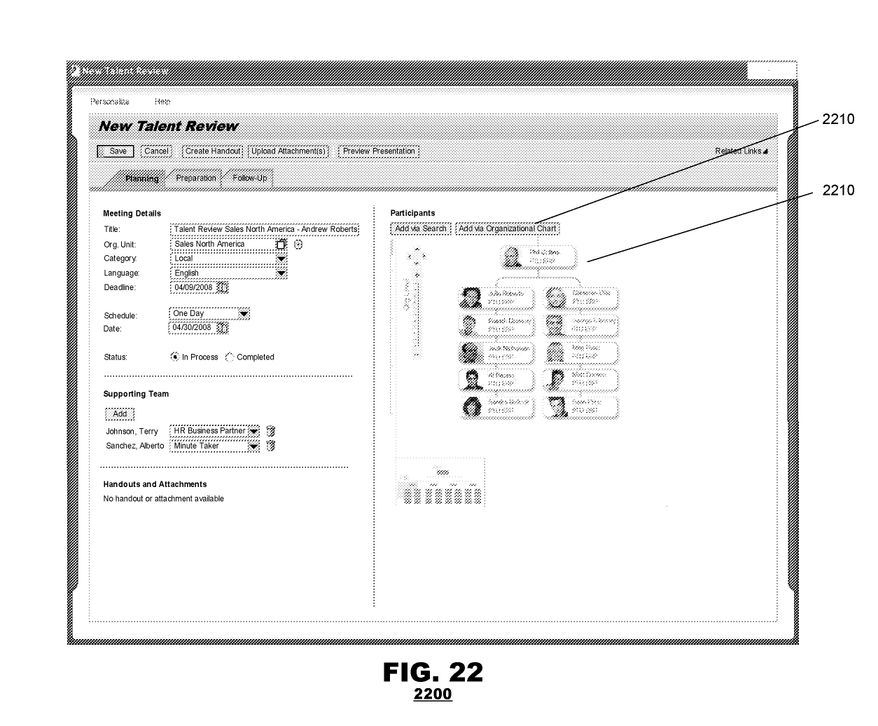

FIG. 22 illustrates an example of an interface for planning similar to FIG. 21 except that button 2210 has been selected to display the participants in an organizational hierarchy 2220 rather than a list.

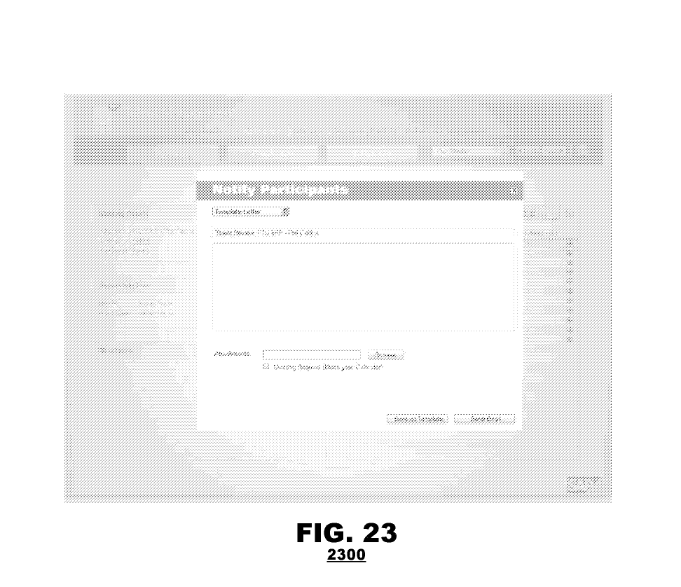

FIG. 23 illustrates an example of an interface for notifying the participants of the talent review meeting of the meeting time and place.

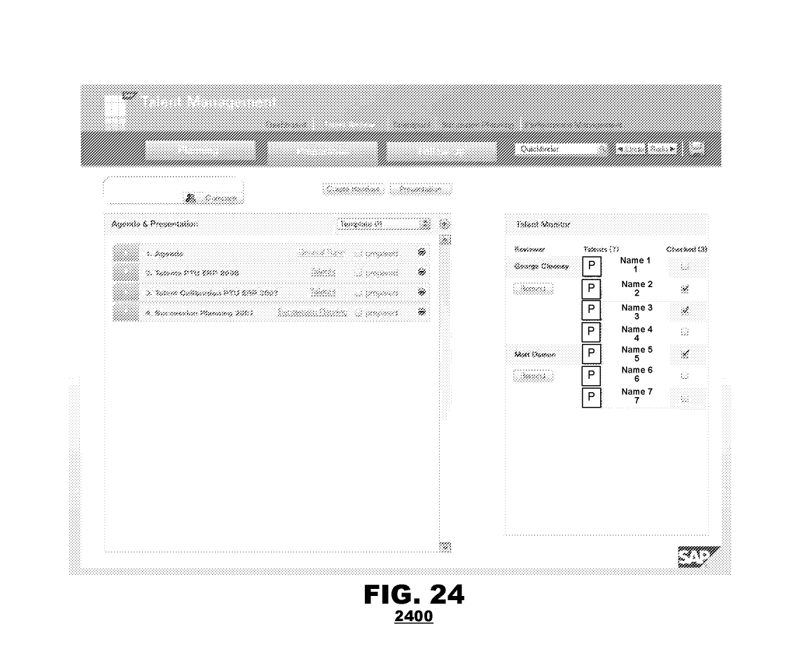

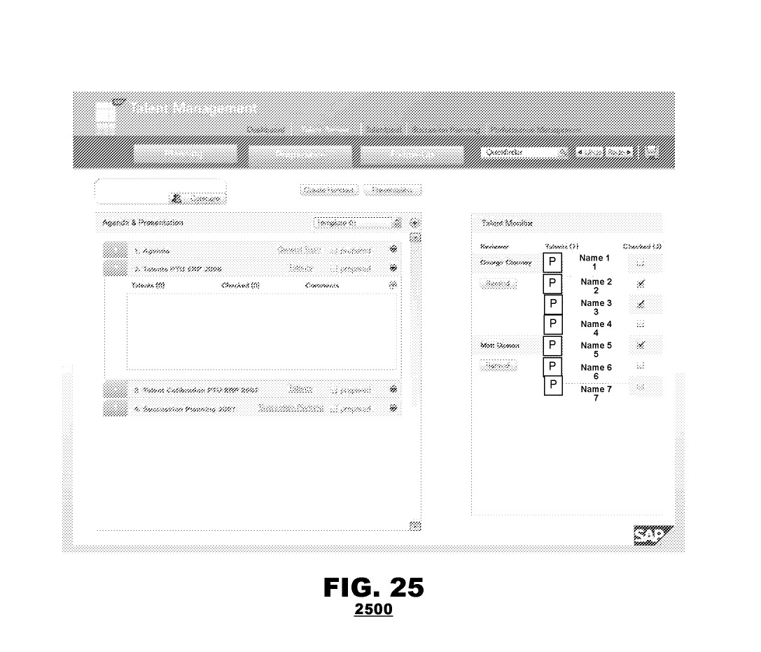

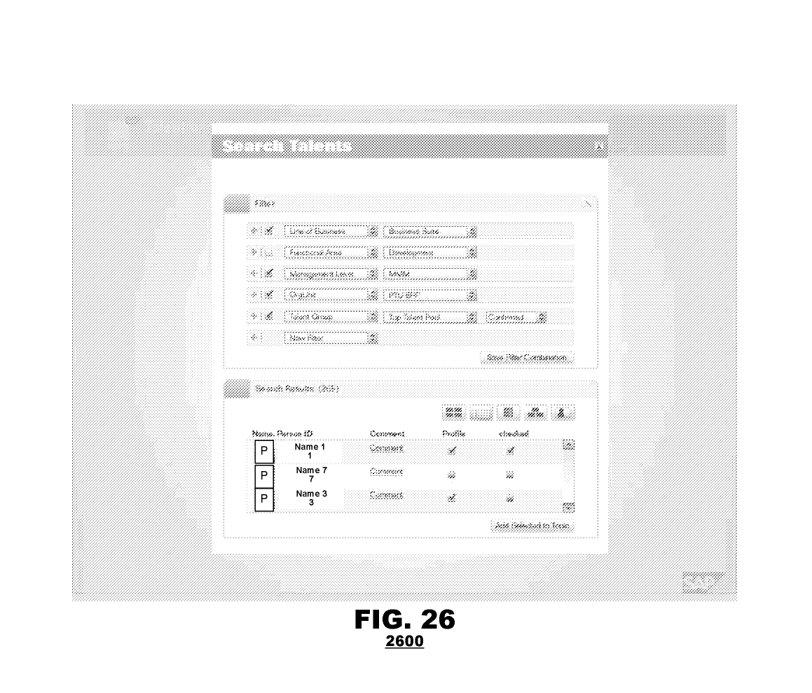

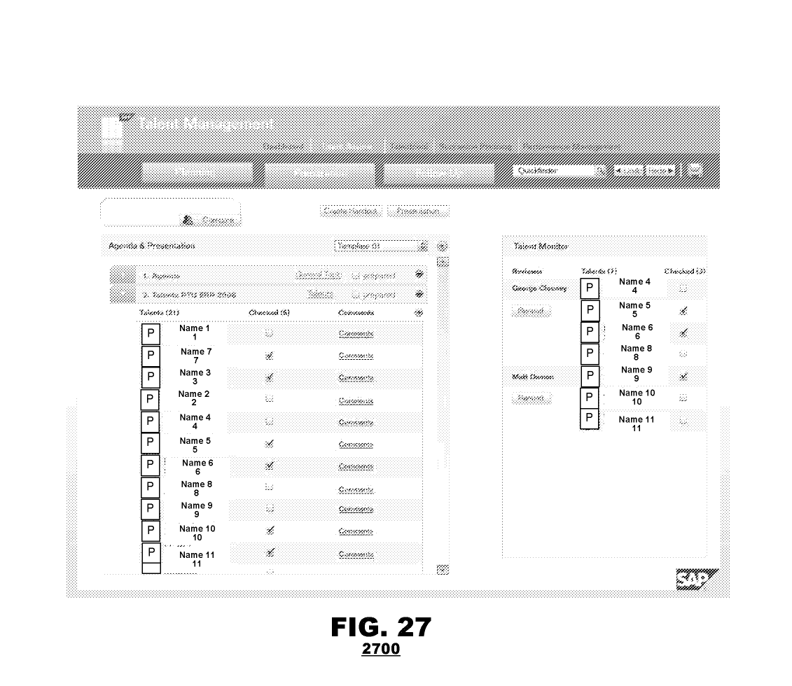

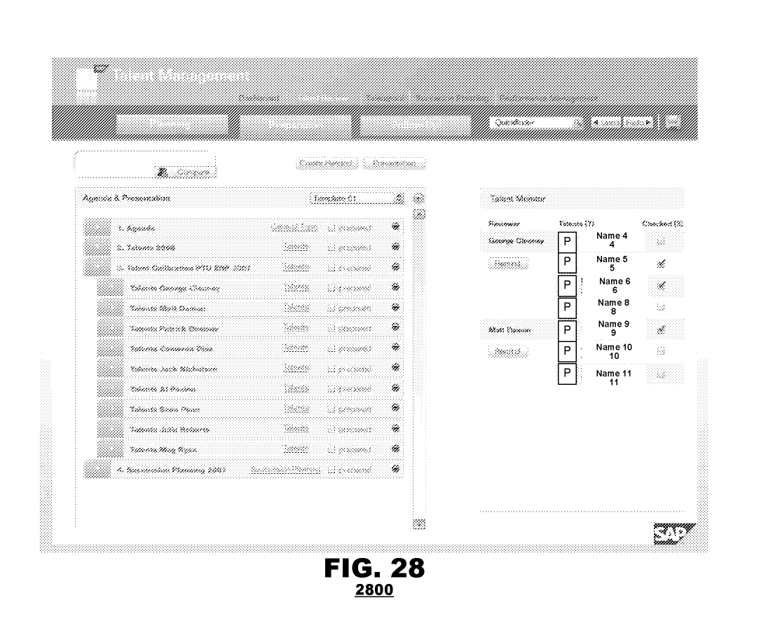

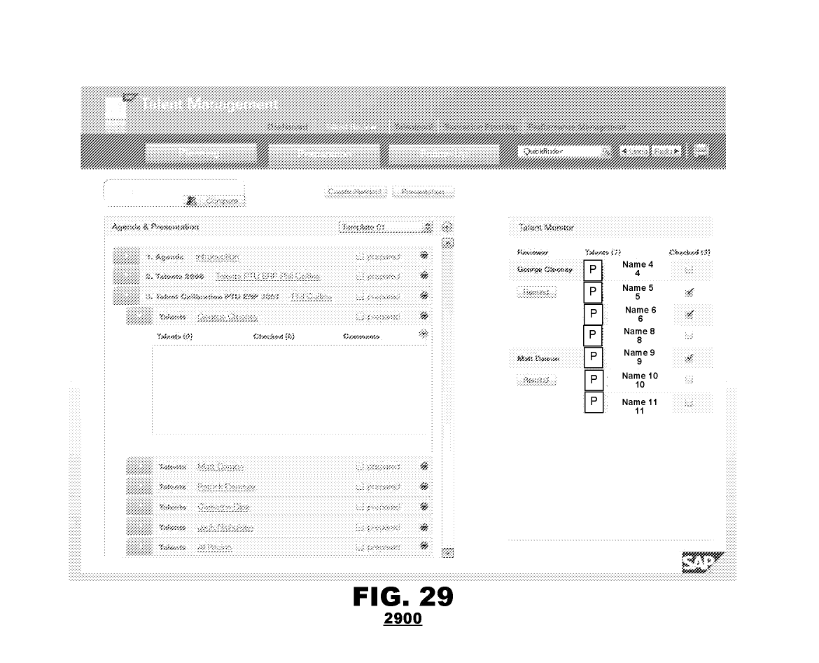

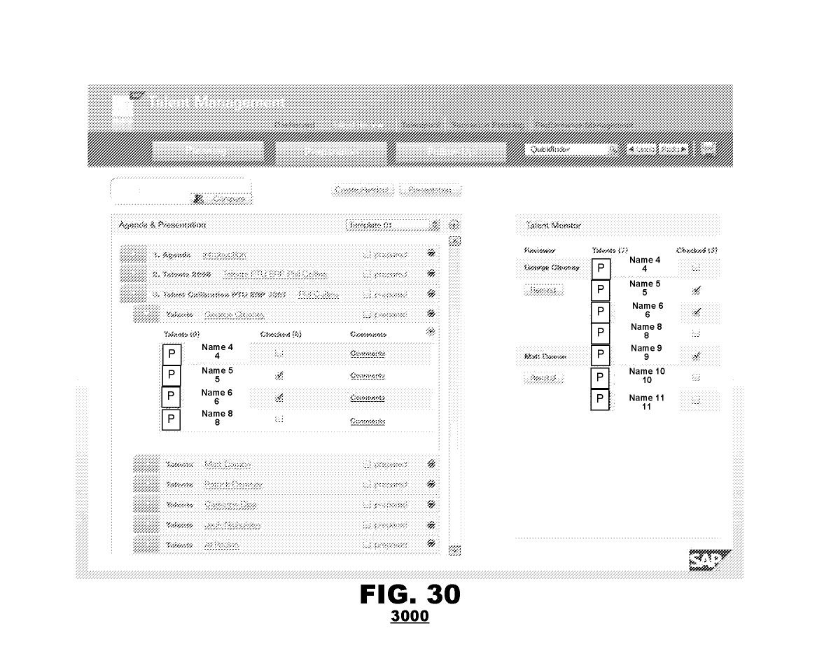

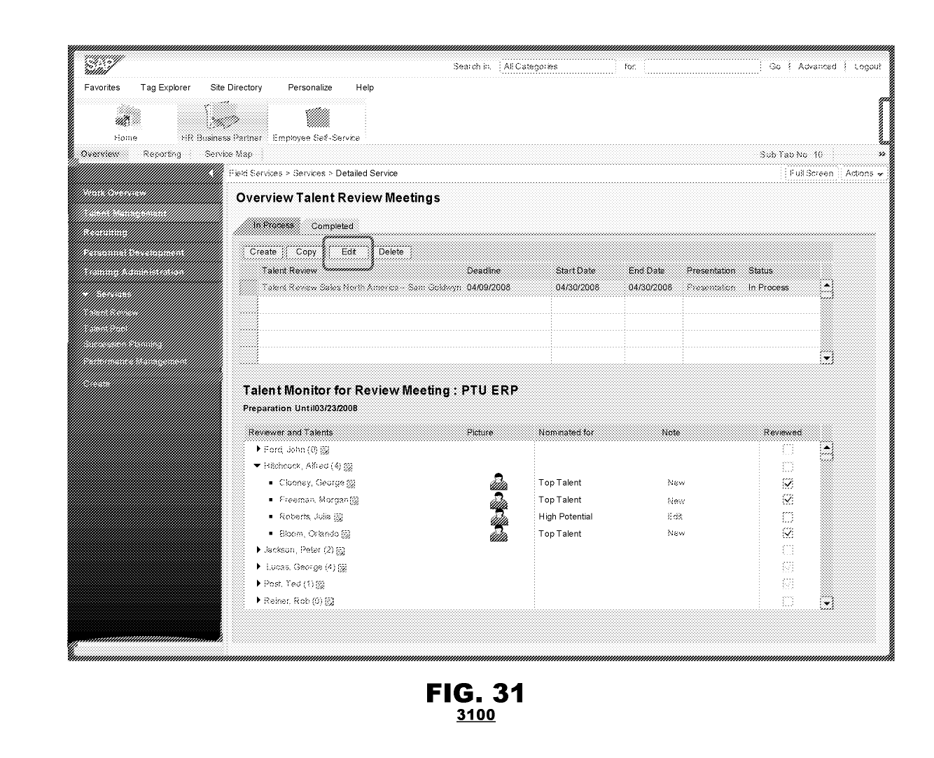

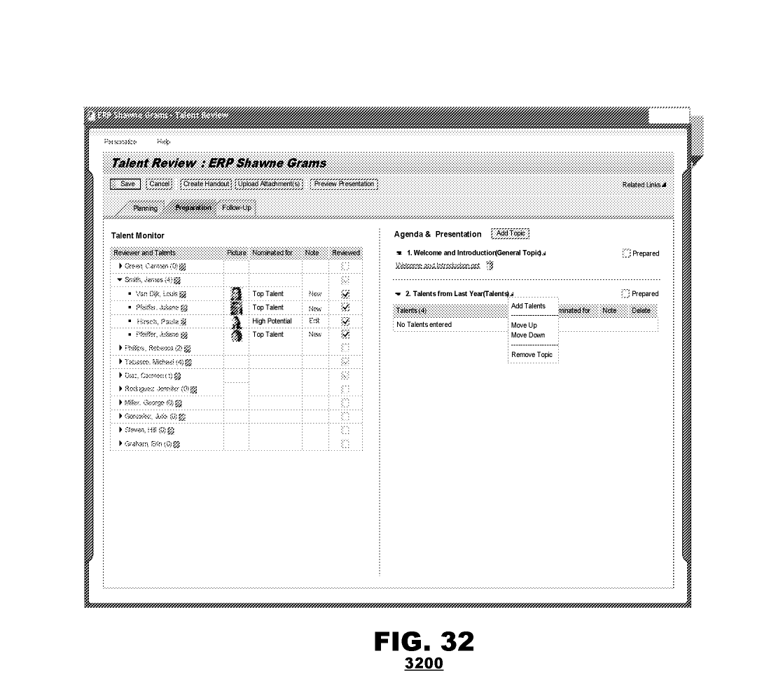

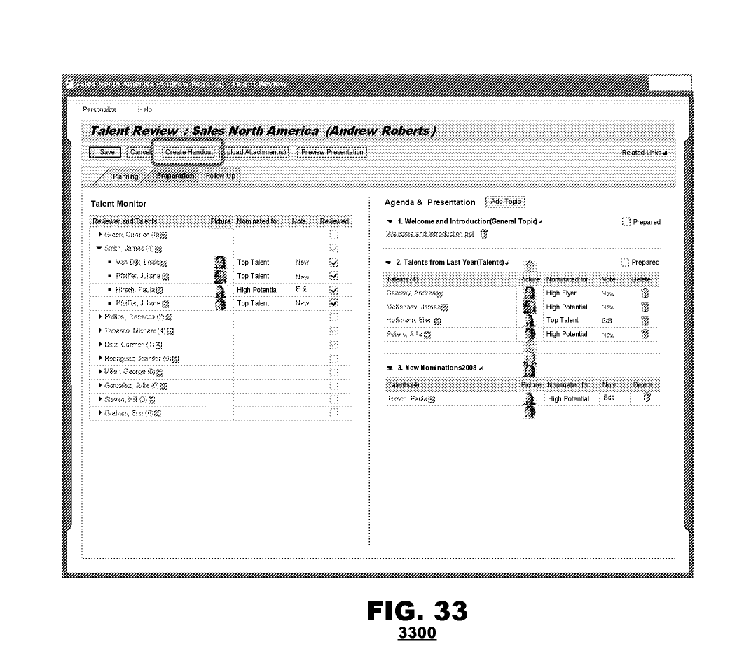

FIGS. 24-33 illustrate examples of the preparation of a talent review meeting, which may include selecting talents for review, creating agendas, selecting succession that need to be filled, selecting talent development, selecting business organization needs, selecting positions that need to be filled, creating slides, editing the talent review meeting, etc.

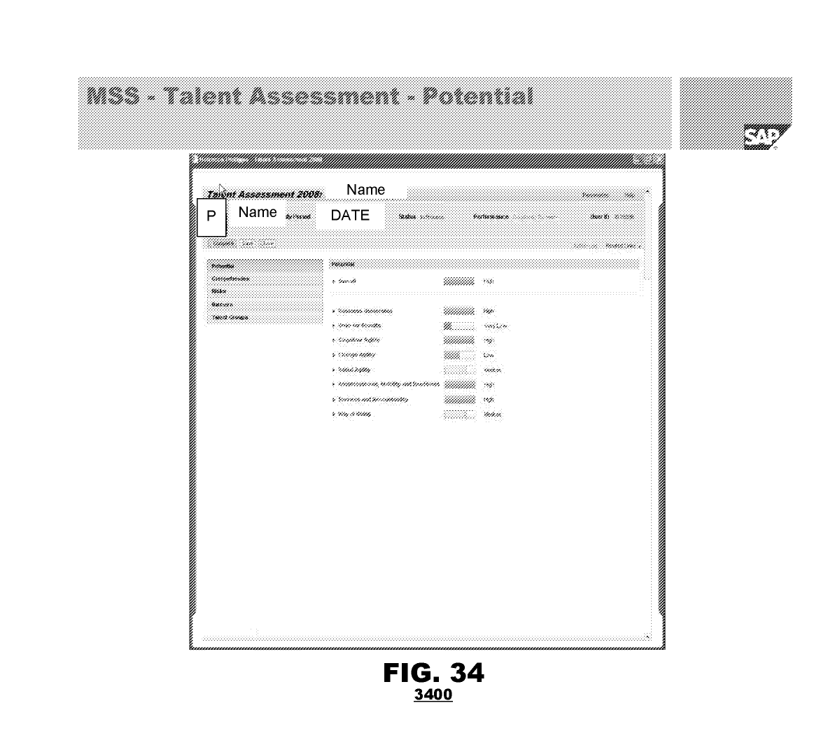

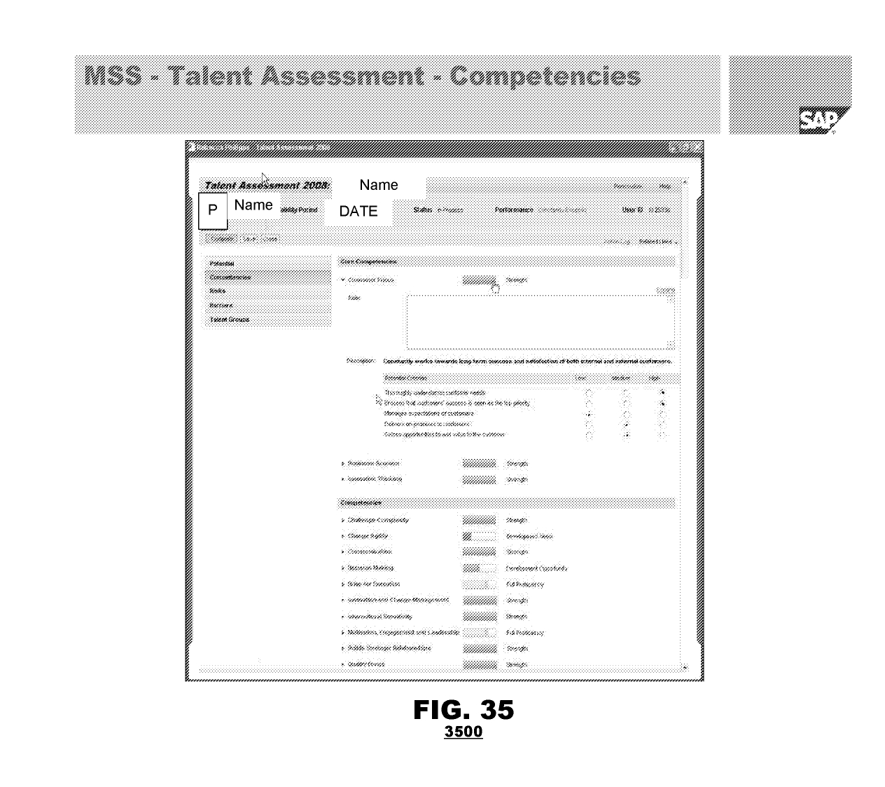

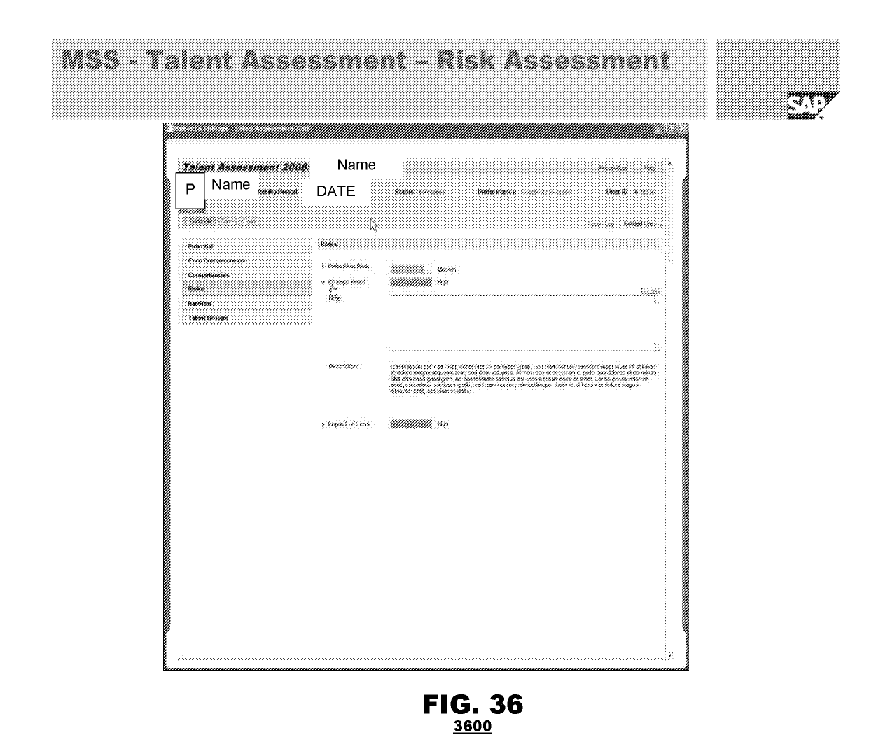

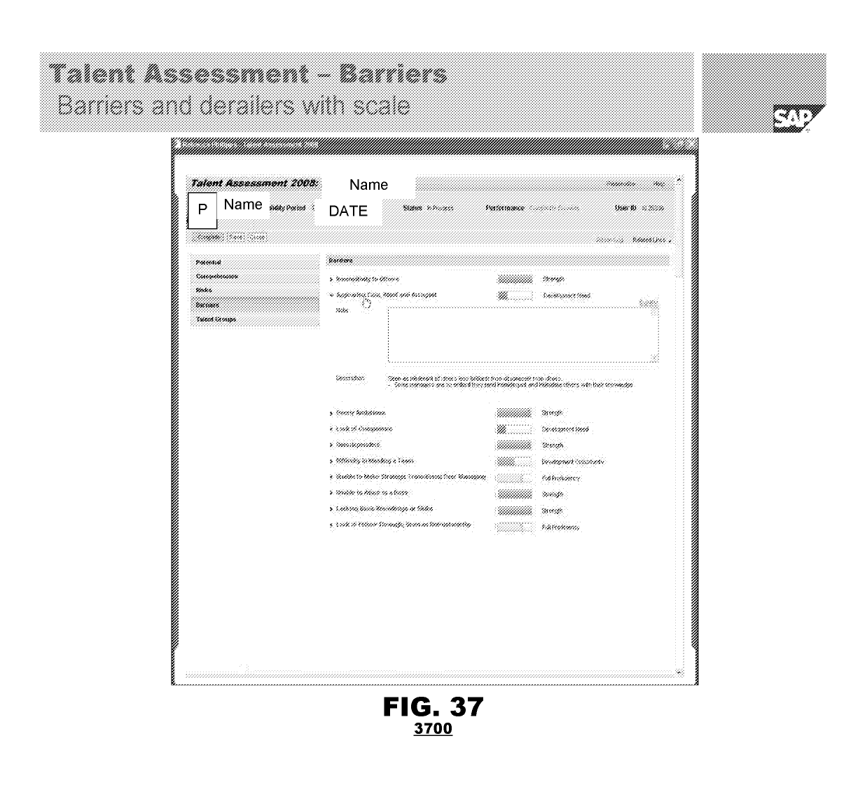

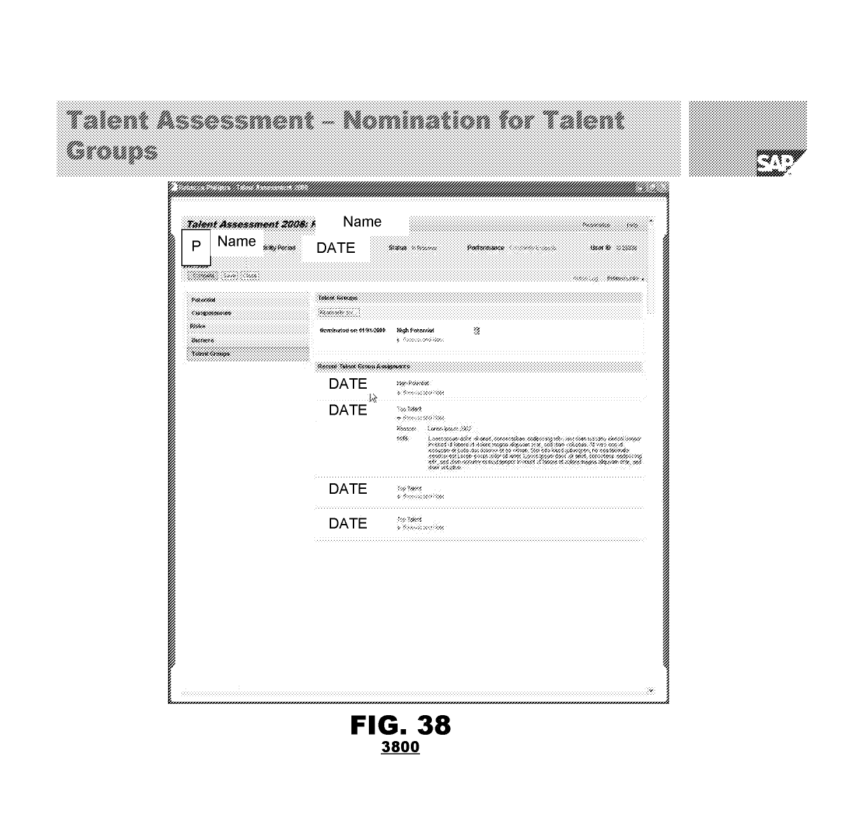

FIGS. 34-38 illustrate examples of the assessment of talent, which may include assessing the potential for an employee, the competencies for an employee, the risk assessments for an employee, the barriers for an employee, and nominating an employee for talent groups.

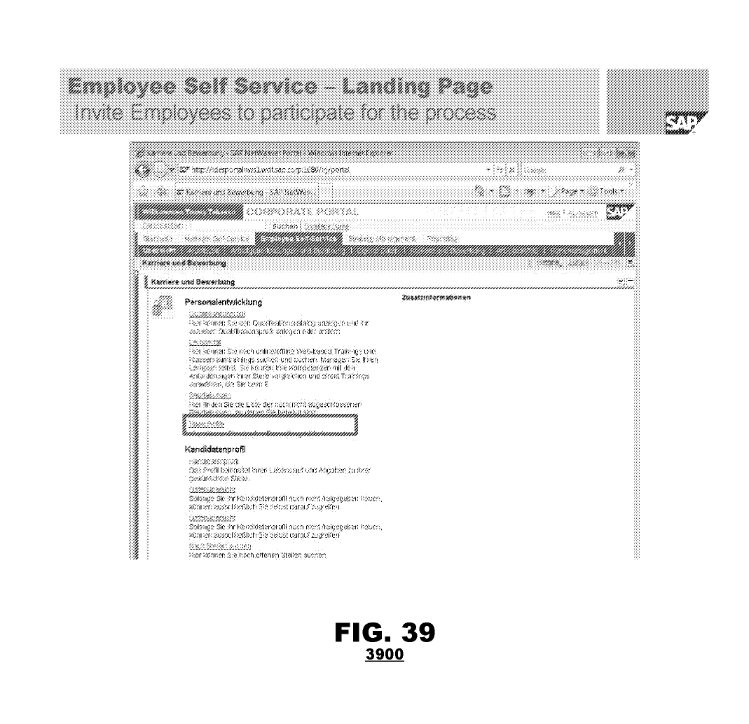

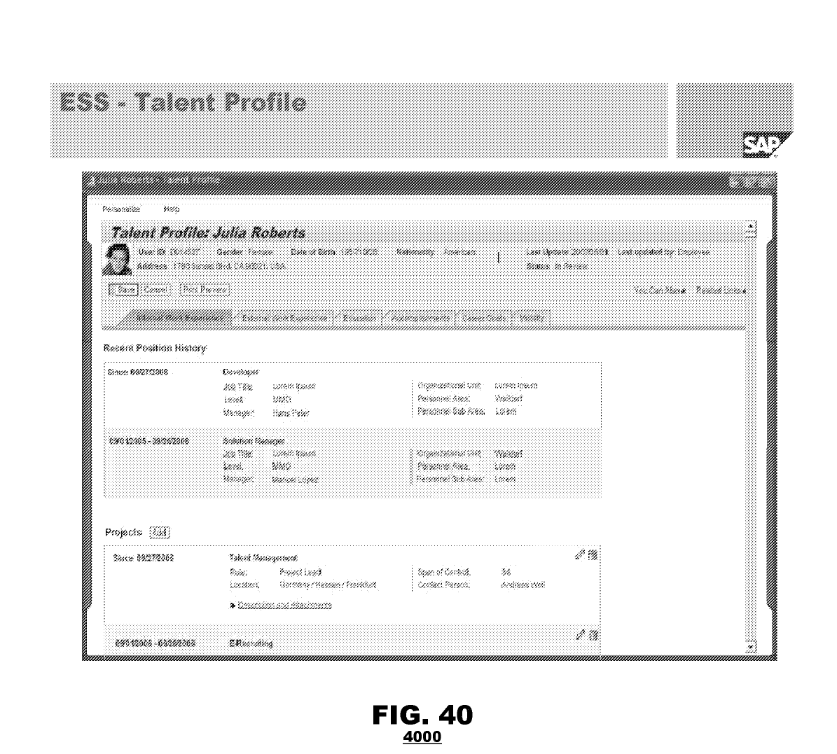

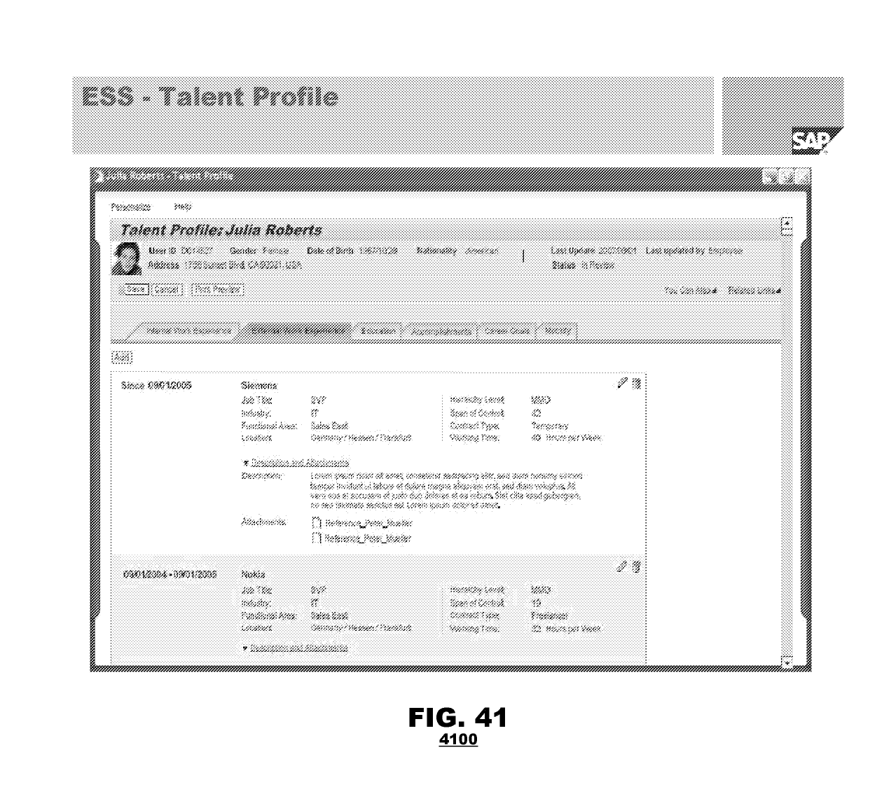

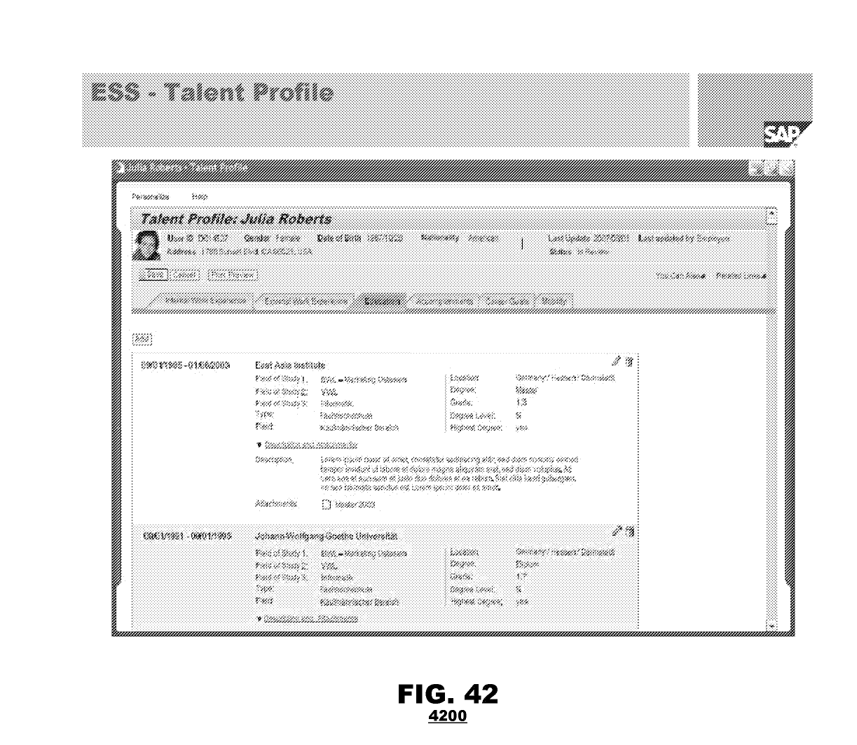

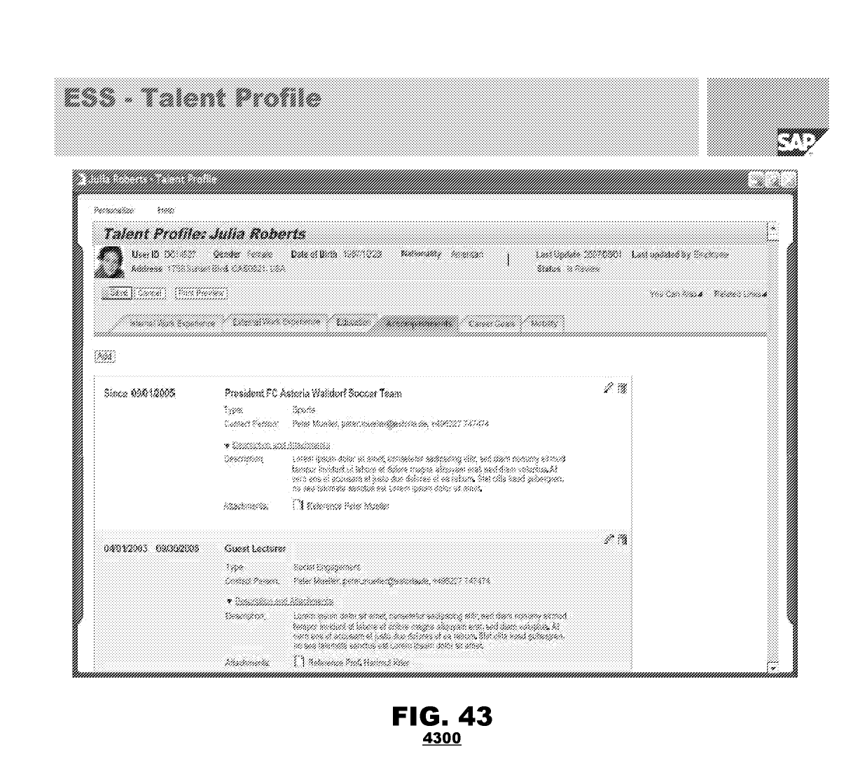

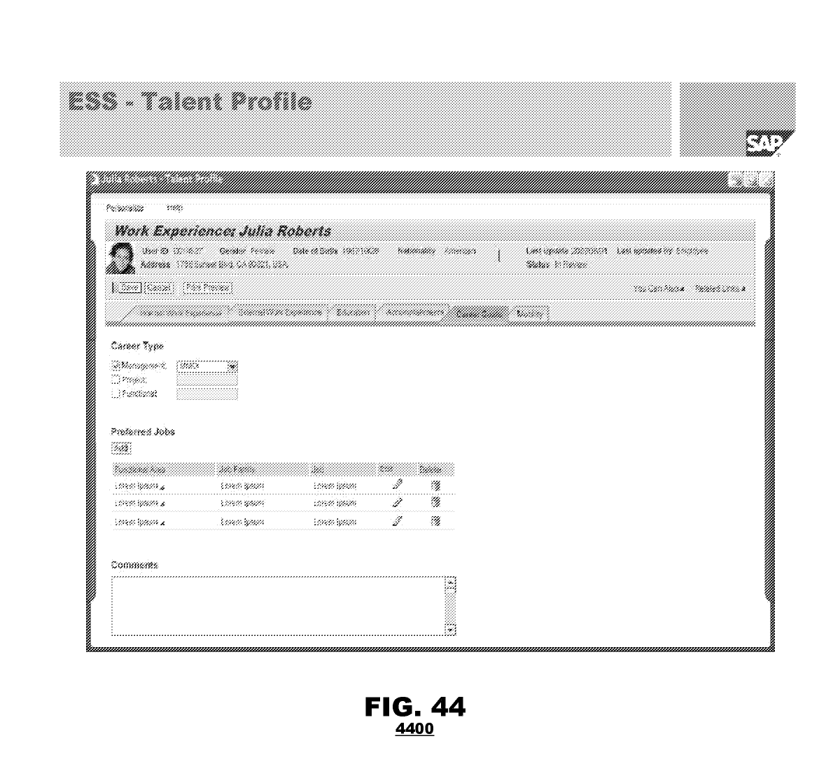

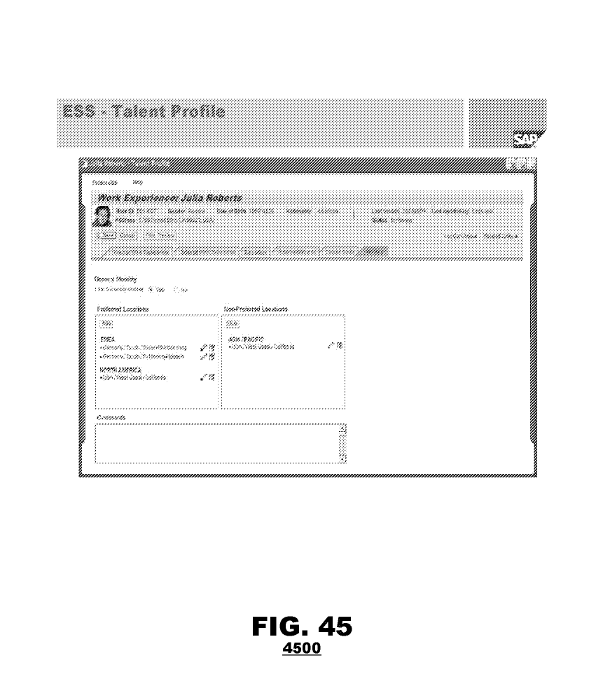

FIGS. 39-45 illustrate examples of the self assessment of a employee, which may include selecting the self assessment from a menu, entering information regarding internal work experience, external work experience, education, accomplishments, career goals, and mobility.

A follow-up after a talent review meeting may include: minutes, talent development follow-up, and succession follow-up.

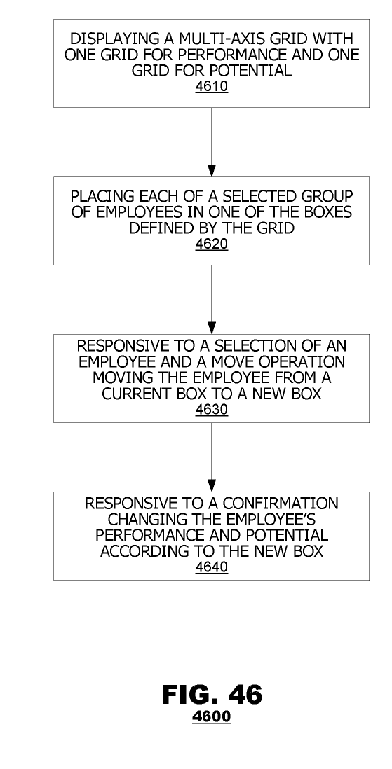

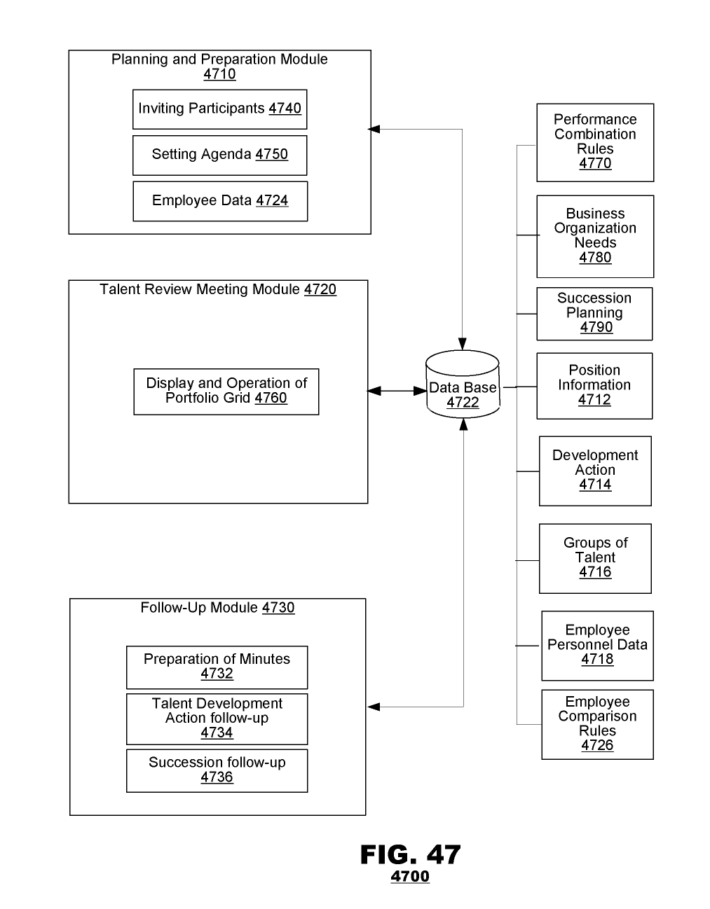

FIG. 46 illustrates an embodiment of a method for reviewing and managing employees. The flow begins at 4610 with displaying a mult-axis grid with one grid for performance and one grid for potential. FIG. 1 is an example of displaying a grid with an axis for performance 140 and an axis for potential 130. The flow continues at 4620 with placing each of a selected group of employees in one of the boxes defined by the grid. FIG. 1 illustrates an example of the result of this operation with the talents 180 each placed in one of the defined boxes. The flow continues at 4630 with responsive to a selection of an employee and a move operation moving the employee from a current box to a new box. FIG. 7 illustrates an example of this operation where name 1 is moved from 720 to 730. As illustrated in FIG. 7 a drag and drop operation was used to move the employee, but other methods may be used to receive an indication that the employee should be moved, e.g. right click on the employee with a menu including an item to move the employee. The flow ends at 4640 with responsive to a confirmation, changing the employee's performance and potential according to the new box. The employee's data as illustrated in FIG. 47 may be updated in the employee personnel data 4718 after a confirmation is received for the employee's new performance and potential values according to the values for the box the employee was moved to in the grid.

FIG. 47 illustrates an embodiment for a system 4700 for reviewing and managing employees. FIG. 47 illustrates a planning and preparation module 4710, a talent review meeting module 4720, a follow-up module 4730, and a database 4722. The database 4722 may be used to store and retrieve data. The planning and preparation module 4710 may in general provide the functionality for planning and preparing a talent review meeting, which may include: invitations, agenda and participants, nominations of talents and proposals for positions and development actions and successions, and handouts for the participants. E.g., the preparation module 4710 may provide the functionality for inviting participants 4740 to a talent review meeting. FIG. 23 illustrates one embodiment of an interface that may be provided by the preparation module 4710 for inviting participants 4740. FIGS. 19-33 illustrate examples of interfaces for planning and preparing a talent review meeting.

Additionally, the planning and preparation module 4710 may include employee data 4724 which may provide the functionality for an employee to maintain the employee data employee personnel data 4718. The business organization needs 4780 may be used to determine which of the personnel data 4718 the employee may enter and change. FIGS. 39-45 illustrate examples of interfaces for an employee to enter personnel data 4718. Additionally, employee data 4724 may provide the functionality for a manager/HR personnel to enter data for an employee into the employee data 4718, the data may include evaluations, etc. FIGS. 34-38 illustrate examples of interfaces for a manger/HR personnel to enter personnel data 4718, including nominating an employee as a talent. In an embodiment, employee comparison rules 4726 may be defined for comparing employees from two local human resource centers that may use different performance values for evaluating employees. The employee comparison rules 4726 may be used by the talent review meeting module 4720 or any module that compares employees.

The talent review meeting module 4720 may provide for the display and operation of a portfolio grid 4760. FIGS. 1-18 illustrate examples of the operation of a portfolio grid. The display and operation of the portfolio grid may include moving existing talents and proposed talents (or confirming or rejecting proposed talents), the review meeting may also include succession planning, providing for decisions to be made for filling open positions, and providing for reviews of development actions for existing talents. Talent review meeting module 4720 may use Performance Combination Rules 4770 for assigning an employee to a performance category in the portfolio grid. The Performance Combination Rules 4770 may be defined by a HR personnel or manager of the company. Talent Review Meeting Module 4720 may use Business Organization Needs 4780 for determining the total number of talents (employees) that can be placed in a box of the portfolio grid. Talent Review Meeting Module 4720 may use Succession Planning 4790 for determining how many talents 110 can be in a succession plan which may determine the number of talents that can be placed in a box of the portfolio grid. The Succession Planning 4790 may include information on the number of talents 110 that can be in a succession plan as well as position information. Talent Review Meeting Module 4720 may use Position Information 4710 for determining information of a position. The Position Information 4710 may be used when comparing talents, e.g. FIG. 8, in selecting what information of the talent to display. Talent Review Meeting Module 4720 may use Groups of Talent 4716 to determine which talents to display for filling positions, or succession planning, or other functions that may use groups of talent 4716. Talent Review Meeting Module 4720 may use employee personnel data 4718 for displaying information of an employee, e.g. FIGS. 11-13. In general, any information associated with personnel may be stored in employee personnel data 4718.

Follow-up module 4730 may provide the following functionality after a talent review meeting: preparing minutes 4732, talent development action follow-up 4734, and succession follow-up 4736, succession follow-up 4736 may include evaluating talents between talent review meetings, granting talents privileges and responsibilities, e.g. special training grants and training goals such as learning a new natural language.

As illustrated the preparation module 4710, talent review meeting module 4720, and follow-up module 4730 are illustrated as single modules, but the functionality may be implemented by multiple modules or a single module. The modules 4710, 4720, and 4730 may be executed on a single computer or multiple computers. The computes may be connected via a network. The data may be stored in a single database, or multiple databases. The databases may be connected via a network. The modules 4710, 4720, 4730 may communicate with people via input and output devices such as display device, mice, touch-screens, speakers, microphones, etc. An advantage to storing the data in a single database may be that data need not be synchronized and there may be less redundant data.

The software modules including program instructions can be stored on computer readable media such as discs, including CD and DVD, flash memory, hard drives including magnetic and optical drives, or any other suitable computer readable media, and that will cause a computer or processor to execute the program instructions. The software language used to write the software modules can be any that is suitable for implementing the described exemplary embodiments, and are known to those of skill in the art.

It should be understood that there exist implementations of other variations and modifications of the invention and its various aspects, as may be readily apparent to those of ordinary skill in the art, and that the invention is not limited by specific embodiments described herein. Features and embodiments described above may be combined with and without each other. It is therefore contemplated to cover any and all modifications, variations, combinations or equivalents that fall within the scope of the basic underlying principals disclosed and claimed herein.

What is claimed is:

1. A computer implemented method for reviewing employees of a company comprising:
displaying a grid with potential along one axis and performance along a second axis;
placing each of a selected group of employees in one of the boxes defined by the grid.

2. The method of claim 1, wherein an indication of previous box placement of the employee is displayed with the employee.

3. The method of claim 1, further comprising:
responsive to a selection of two of the employees,
displaying a side-by-side comparison of the two employees for evaluating the two employees.

4. The method of claim 3, wherein the side-by-side comparison is based on a position in the company that the two employees are being considered for.

5. The method of claim 1, further comprising:
defining a set of rules for placing the selected group of employees in boxes;
retrieving evaluations of the selected group of employees from at least two local human resources centers that use different performance values for evaluating the selected group of employees;
placing each of the selected group of employee in one of the boxes using the rules.

6. The method of claim 1, further comprising:
displaying with a box a number of employees that can be confirmed members of the box.

7. The method of claim 6, wherein the number of employees that can be confirmed members of the box is dependent on business organization needs.

8. The method of claim 6, wherein an employee being a member of a box, assigns the employee a particular organizational role that at least partially defines an employee evaluation criteria and an employee's duties.

9. The method of claim 1, further comprising:
responsive to a selection of an employee and a drag-and-drop operation moving the employee from a current box to a new box,
displaying the employee in the new box;
displaying with the employee in the new box an indication from where the employee was moved from.

10. The method of claim 9, wherein displaying comprises:
displaying the employee with an indication that the employee movement from the current box to the new box is unconfirmed.

11. The method of claim 10, further comprising:
responsive to a selection of making an employee movement confirmation,
displaying with the employee an indication that the movement is confirmed.

12. The method of claim 1, wherein a single database is used to store and retrieve data.

13. A computer readable medium embodied with instructions for a method for reviewing employees of a company, the instructions causing a computer to execute the method, comprising
displaying a grid with potential along one axis and performance along a second axis; and
placing each of a selected group of employees in one of the boxes defined by the grid.

14. The computer readable medium of claim 13, wherein an indication of previous box placement of the employee is displayed with the employee.

15. The computer readable medium of claim 13, further comprising:
responsive to a selection of two of the employees,
displaying a side-by-side comparison of the two employees for evaluating the two employees.

16. The computer readable medium of claim 15, wherein the side-by-side comparison is based on a position in the company that the two employees are being considered for.

17. The computer readable medium of claim 13, further comprising:
defining a set of rules for placing the selected group of employees in boxes;
retrieving evaluations of the selected group of employees from at least two local human resources centers that use different performance values for evaluating the selected group of employees;
placing each of the selected group of employee in one of the boxes using the rules.

18. The computer readable medium of claim 13, further comprising:
displaying with a box a number of employees that can be confirmed members of the box.

19. The computer readable medium of claim 18, wherein the number of employees that can be confirmed members of the box is dependent on business organization needs.

20. The computer readable medium of claim 18, wherein an employee being a member of a box, assigns the employee a particular organizational role that at least partially defines the employee evaluation criteria and the employee's duties.

21. The computer readable medium of claim 13, further comprising:
responsive to a selection of an employee and a drag-and-drop operation moving the employee from a current box to a new box,
displaying the employee in the new box;
displaying with the employee in the new box an indication from where the employee was moved from.

22. The computer readable medium of claim 21, wherein displaying comprises:
displaying the employee with an indication that the employee movement from the current box to the new box is unconfirmed.

23. The computer readable medium of claim 22, further comprising:
responsive to a selection of making an employee movement confirmation,
displaying with the employee an indication that the movement is confirmed.

24. The computer readable medium of claim 12, wherein a single database is used to store and retrieve data.

25. A system for reviewing employees of a company, comprising:
a display device for displaying a graphical user interface;
a processor connected to the display device and configured to receive inputs from the graphical user interface, the processor comprising:
a first module for displaying a grid with potential along one axis and performance along a second axis;
a second module for placing each of a selected group of employees in one of the boxes defined by the grid;
a third module for responding to a selection of two of the employees by displaying a side-by-side comparison of the two employees for evaluating the two employees;
a fourth module for responding to a selection of an employee and a drag-and-drop operation by moving the employee from a current box to a new box; and
a data storage for storing the results of employee movements by the fourth module and for storing information of the employees, the company, and the employee review.
